(19) United States
(12) Patent Application Publication
(10) Pub. No.: US 2023/0306795 A1
(43) Pub. Date: Sep. 28, 2023

(54) MACHINE-ENABLED FARMING

(71) Applicant: BASF AGRO TRADEMARKS GMBH, Ludwigshafen (DE)

(72) Inventors: Thomas LECHNER, Münster (DE); Clemens VON HARDENBERG, Köln (DE); Marcel Enzo GAUER, Köln (DE); Stefan HANEBRINK, Köln (DE); Maria TACKENBERG, Münster (DE); Ole JANSSEN, Dormagen (DE)

(21) Appl. No.: 18/021,932

(22) PCT Filed: Aug. 27, 2021
(86) PCT No.: PCT/EP2021/073773

§ 371 Date: Feb. 17, 2023

(30) Foreign Application Priority Data
Aug. 31, 2020 (EP) 20193658.0
Oct. 23, 2020 (EP) 20203513.0

(51) Int. Cl. G07C 5/00; A01C 21/00; G07C 5/08

(52) U.S. Cl. CPC G07C 5/008; A01C 21/005; G07C 5/0808

(57) ABSTRACT

The present teachings relate to a method for validating an agricultural farming operation prior to and/or during executing an agricultural farming operation at a geographical location using a machine, the machine being operatively coupled to a computing unit, which method comprises: —providing to the computing unit one or more signals retrieved from the machine; the one or more signals being indicative of one or more parameters related to the machine and/or to the farming operation; —determining, via the computing unit, whether any one or more of the parameters related to the machine and/or to the farming operation lie within an acceptable range or value, which acceptable range or value is specified using field specific data that are provided at a memory storage operatively coupled to the computing unit; and—generating, via the computing unit, an output signal in response to the determination; wherein the output signal is usable for validating and/or specifying the farming operation to monitor and/or control the machine. The teachings also relate to a machine, a software product and a computing unit.

### TECHNICAL FIELD

The present teachings relate generally to machine-based farming operations and products.

### BACKGROUND ART

In the technical field of agriculture, there is steady push to make farming or farming operations more sustainable. Precision farming or agriculture is seen as one of the ways to achieve better sustainability and reducing environmental impact. To date various approaches towards more precise farming have emerged, most of which are digitally enabled. As an example, one such approach includes smart application of crop protection products. An overall goal in precision farming is to create such a system for farm management that optimizes returns on inputs, such as land area and costs, while maximizing preservation of resources.

Such systems may be developed and supplied by third party suppliers who may have invested extensive efforts and costs in experiments and research in developing them. Accordingly, the optimization of farming operations may be developed by a supplier and not by the farmer themselves. Since farming operations must adapt to the ever-changing conditions in the field or at the site of the crop, the performance of farming operations under ideal conditions is difficult to achieve hampering reliability of farming operations.

US 2017 316124 A1 discloses a system an application controller programmed or configured to receive instructions from agricultural intelligence computer system. Application controller may also be programmed or configured to control an operating parameter of an agricultural vehicle or implement. Agricultural intelligence computer sends the one or more recommendations to communication layer. Communication layer may use the recommendations for water application, nutrient application, or enhanced efficiency agrochemical application to create application parameters for application controller. In response to receiving the recommendation, communication layer may use the nutrient availability data to create application parameters for a nutrient release valve that describe an amount of a nutrient to release on to the one or more fields. Presentation layer may then send a notification to field manager computing device indicating the nutrient availability data and requesting permission to apply the recommended nutrient to the one or more fields. In response to receiving permission to apply the recommended nutrient, communication layer may send the application parameters to application controller. Application controller may then implement the application parameters, such as releasing nitrogen onto the one or more fields or increasing the amount of water released to a specific crop.

There is further need to improve farm operations by providing more robust farm management systems and associated components, including methods, which can improve the reliability of farming operations.

### SUMMARY

At least some of the problems inherent to the prior-art will be shown solved by the subject matter of the accompanying independent claims. At least some of the further advantageous alternatives will be outlined in the dependent claims.

The applicant has realized that in the field of precision farming that is conducted, for example on fields, there is a need to adapt farming operations according to the current conditions. This can provide a more sustainable-farming or a more sustainable way for cultivating one or more crops.

Accordingly, when viewed from a first perspective, there can be provided a method for performing an agricultural farming operation at a geographical location using an agricultural machine, preferably a method for validating an agricultural farming operation prior to and/or during executing an agricultural farming operation at a geographical location using a machine, the machine being operatively coupled to a computing unit, which method comprises the steps of:
providing to the computing unit or analyzing, via the computing unit, one or more signals retrieved from the machine; the one or more signals being indicative of one or more parameters related to the machine and/or to the farming operation;
determining, via the computing unit, whether any one or more of the parameters related to the machine and/or t the farming operation lie within an acceptable range or value, which acceptable range or value is specified using field specific data, preferably the field specific data relates to the machine and/or the farming operation and/or the validation data and/or the one or more validation rules, that are provided at a memory storage operatively coupled to the computing unit; and
generating, via the computing unit, an output signal in response to the determination; wherein the output signal is usable for validating and/or specifying the farming operation to monitor and/or control the machine.

By determining the acceptability of parameters related to the agricultural machine and/or to the farming operation based on field specific data, that are provided at a memory storage operatively coupled to the computing unit prior to execution of the farming operation, the validity of the operation parameters specifying the farming operation to be conducted can be ensured. This is particularly relevant for distributed systems, where field specific data tailored to forecasted field conditions is prepared and provided to the agricultural machine prior to execution of the farming operation. The field conditions may change between downloading the field specific data and executing the farming operation. In such case the farming operation may not fit the field conditions anymore without the operating noting. More importantly a certain field health may not be ensured with such sub-optimal or even harming farming operations. As a result, a validation or check prior to execution of the farming operation increases the reliability of farming operations to be executed.

“Performing” in the context of a farming operation will be understood as a general term that encompasses at least a part of any one or more farming related activities in any phase. The term may hence include selecting a particular farming operation, e.g., with a purpose to conduct, execute, or carry out at the geographical location. Additionally, or alternatively, “performing” or “to perform” a farming operation may include “validating” the farming operation, e.g., for a particular geographical location. Additionally, or alternatively, “performing” or “to perform” a farming operation may include “conducting”, executing, or carrying out the farming operation, via the machine, at any geographical location. Additionally, or alternatively, “performing” or “to perform” a farming operation may include “controlling” or regulating, and/or “steering” the farming operation, e.g., via the computing unit and/or the machine. It shall be clear that the terms “performing a farming operation” or “to perform a farming operation” may also include “preventing” or “to prevent” the farming operation to be conducted.

That the machine is “operatively coupled” to the computing unit shall be clear to those skilled in the art. In a non-limiting manner, this means that there may at least be a communicative connection between the machine and the computing unit e.g., via the connectivity interface. The computing device may be separate from the machine and in communicative connection to the machine via the connectivity interface or the computing device may be part of the machine and in communicative connection via the connectivity interface. The communicative connection may either be fixed it or it may be removable, as it will discussed in more detail later in this disclosure. Moreover, the communicative connection may either be unidirectional, or it may be bidirectional. Furthermore, the communicative connection may be wired and/or wireless. In some cases, at least some parts of the machine or the machine itself may be at least partially controllable by the computing unit via the communicative connection.

“Field specific data” refers to data related to a field which the geographical location is associated with. Field specific data may include data related to the performance of the farming operation. The field specific data may at least in part include data specific to the geographic location. The field specific data may be include control data associated with the performance of the farming operation. The geographical area may by located within a certain distance from the field, or more preferably the geographical location may signify the location or the field. The geographical area may be part of the field.

“Parameter” in this context refers to any relevant physical or chemical characteristic and/or a measure thereof, such as temperature, direction, heading, precipitation, position, quantity, density, weight, biomass, light, color, humidity, solar radiation, bee activity, speed, acceleration, rate of change, pressure, force, distance, pH, concentration, genetics, chemical, and level. The parameter may also refer to a presence or lack thereof of a certain characteristic. It will be appreciated that the characteristic may relate to any entity related to the machine and/or the geographical location and/or the farming operation. Parameters related to the machine and/or to the farming operation may be associated with machine parameters and/or farming operation parameters that impact the efficiency and efficacy of the farming operation to be conducted. For example, wind speed at the geographical location, direction of a specific part of the machine, location of the machine, flowrate of an agricultural substance during the farming operation, date, or time.

“Value” refers to a numerical value of any parameter or quantity. The value may even be a binary value, for example, a result of a binary detection such as a proximity detection, or any other kind of “on”-“off” type characteristic. For example, a temperature value, pH value, geographical coordinates, and enabled- or disabled-status.

“Range” may refer to a set or string of values, continuous or discrete, floating-point or real, or even integer values. The set of values have as their boundary the smallest value of the range on one side, and the largest value of the range on the other side. The range can for example be a time-range delimited by an earliest time value and a latest time value. Other non-limiting examples of a range in context of the present disclosure are: temperature range, pressure range, distance range, level range, concentration range, strength range, force range, speed range, acceleration range, power range, pH range, radiation range, diameter range, work area range, height range, etc.

The “acceptable value or range” may refer to a value or range associated with the parameter related to the machine and/or to the farming operation. A value or range is acceptable, if the parameter related to the machine and/or to the farming operation lies within a value or range. The value may signify a threshold. The range may signify a range between two values. An acceptable range or value may signify the value or range that allows for safe farming operation.

The “output signal” is usable for validating and/or specifying the farming operation. The computing unit via the output signal may either provide a determination of the validation and/or speciation of the farming operation, and/or the computing unit may provide as the output signal a basis or a computer logic for further processing, either using the computing unit or another computer processor, with or without requiring additional data. For example, the additional data may be user preferences and/or any data which is not available at the time for making a determination. The computing unit, as a part of the output signal, or as another signal, may indicate which data are further required for validation and/or speciation of the farming operation. The output signal may be associated with control data related to the validation and/or specification of the farming operation to monitor and/or control the machine.

“Validating” in the present context refers to determining whether a given farming operation may be conducted or not. Certain farming operations such as dissemination of an agricultural substance, more specifically chemical, biological or pharmaceutical substances such as fungicide, insecticide, herbicide, plant growth regulator, urease inhibitor, nitrification inhibitor, denitrification inhibitor, or fertilizer may be sensitive to the environmental conditions that exist at, or around, the geographical location at the time of conducting dissemination. Even though an application of such a substance may have been recommended or specified with certain characteristics earlier, the conditions on the field, or more specifically those on the geographical location, may have since changed such that the earlier specified characteristics for dissemination or application may not be valid or favorable anymore. Such a farming operation if conducted may not be effective, result in wastage or not result in a beneficial effect. In worst case scenario, such a dissemination with outdated characteristics may even harm the field or may even damage the crop if the crop is present on the field, or have a detrimental effect on future crop. The output signal may hence be usable in validating the farming operation by determining whether the conditions on the geographical location favor the conducting of the farming operation.

“Specifying” in the present context refers to selecting or determining one or more characteristics of the farming operation. Specifying the farming operation to monitor and/or control the machine may include generating farming operation parameters usable or used to monitor and/or control the machine. The farming operation parameters may be provided to the machine. The farming operation parameters may be used by the machine to monitor and/or control the machine during performance or execution of the farming operation. For example, if the farming operation involves dissemination of an agricultural substance at the geographical location then the output signal may be usable for determining with which concentration and/or amount of the agricultural substance should be disseminated at the geographical location. The output signal may even be usable in specifying the farming operation at another geographical location. The characteristics may even be temperature or pressure, their respective values or even ranges within which the agricultural substance should be disseminated. The characteristics of the farming operation may even include a parameter related to the machine, for example, speed of the machine, nozzle type and/or size of a sprayer, pressure value, and distance within which two adjacent farming operations may be conducted. The characteristics of the farming operation may even be related to the environmental conditions at or around the geographical location, for example, ambient temperature, wind speed, wind direction, their respective values or even ranges within which the farming operation may be conducted.

“Agricultural” or “agriculture” also encompasses animal husbandry, aquaculture, horticulture, and silviculture.

“Farming operation” refers to any kind of activity related to at least one crop. The activity may be performed or conducted at least partially via the machine at the geographical location, preferable an agricultural field or a field. Such field may be an open field or an enclosed area such as a tank, pool, yard, pen or a hall. The farming operation may relate to any treatment of an agricultural field. The farming operation may include nitrogen applications, planting procedures, soil application, tillage procedures, irrigation practices, crop protection product application or the like. The farming operation may be performed in any phase of the cultivation. The performance may be either prior to, during or after the crop is present on the geographical location. As non-limiting representative examples, the cultivation phases can be any of: seeding, breeding, tending, feeding, raising, treating, irrigating, harvesting, or tilling.

“Field” refers to a geographical area of land, enclosed or otherwise, used for agricultural purposes. Preferably the field refers to a geographical area cultivating crops. The field may be identified by geographical location and a shape associated with the field. The field may include buffer zones, which may relate to safety zones, where certain farming operations may not be conducted. In the present disclosure, field may be used to refer to any kind of open or enclosed area that is suitable for cultivating any one or more crops, either of the same kind or different, for example via agriculture, aquaculture or algaculture. Accordingly, areas such as ponds, pools, aquatic farms, pens and yards that are used for cultivation of any one or more plants, animals, or aquatic organisms such as fish and algae may also lie within the ambit of the term “field”. The field may comprise a plurality of geographical locations either as single points or patches of geographical areas having similar or dissimilar area values. In some cases, the field may be fully defined with a plurality of geographical locations.

“Crop” refers to a product, plant or animal, that can be grown and harvested for profit or subsistence. The crop may be cultivated in agriculture or in aquaculture, or even in algaculture. The crop may be cultivated on a field. The crop may be cultivated indoors or outdoors. The crop may be a food crop, such as food grains, feed crop, edible seeds, fruits or vegetables, livestock, poultry or aquatic organisms such as aquatic plants, algae, fish, molluscs and crustaceans, or it may even be a non-food crop, such as floriculture, turf or an industrial crop such as biofuel or fiber. Movable crops may, for example, be optically recognized via suitable detection components or sensors such as one or more cameras and/or using identification tags, optical and/or electronic such as Radio-frequency identification (“RFID”) tags.

“Geographical location” refers to any location or place that denotes a point or an area on the Earth's surface or elsewhere.

“Machine” in this context refers to any agricultural machine such as a sprayer, seeder, tiller, stirrer, mixer, harvester, tractor or any other kind of agricultural machines used in any phase of agriculture or cultivation of any kind of crop. The machine may by configured to treat the agricultural field or field. The machine may even be a combination of two or more of these or other farm- or agricultural-machines. For example, in some cases a tractor may comprise a tiller, and/or a seeder, and/or a sprayer. The cultivation phases can for example be any of: seeding, breeding, tending, feeding, raising, treating, irrigating, harvesting, or tilling. For example, seeding a plant crop, breeding an animal, tending or treating an animal or a plant crop, irrigating a field of crop, harvesting a crop, or tilling a field is a non-limiting and non-extensive use of the terms in context of a farming operation or activity. Preferably, the machine is a smart machine, for example, a smart sprayer or a smart seeding system. Accordingly, the smart machine possesses some sort of intelligence by virtue of one or more sensors and preferably one or more computer processors. The smart machine may even comprise one or more actuators operatively coupled to the one or more computer processors.

“Agricultural substance” may be any substance, organic or inorganic, that is suitable for agricultural application or use. More specifically, agricultural substance may be a chemical, biological, pharmaceutical substance, microorganism or any of their combinations. According to an aspect, the agricultural substance may comprise one or more active ingredients for improving one or more properties of the crop. For example, the agricultural substance may be any one, or it may comprise a combination of any two or more, of: water, fungicide, insecticide, herbicide, bactericide, plant growth regulator, urease inhibitor, nitrification inhibitor, denitrification inhibitor, any suitable disinfectant or other pharmaceutical substance, plant seed, mulch, feed, and fertilizer.

“Dissemination” in the present context refers to any kind or application or dispersal of one or more agricultural substances at the geographical location. More specifically, dissemination may refer to any one or more of: application of water or irrigation, application of one or more active ingredients or products of agricultural substances for treatment, removal or prevention of any unwanted organic or inorganic object or entity such as pest, disease, weed, parasite at the geographical location. Dissemination may even refer to sowing a crop by seeding or planting. Dissemination may be conducted in any suitable manner, such as by placing, releasing, spreading, scattering, spraying and fumigating, injecting or any of their suitable combination, either above or below a surface such as ground, or water. Dissemination may be done at the geographical location over a pre-existing crop, and/or it may be done whilst performing cultivation, stirring, filtering, feeding, sowing, tilling and/or harvesting.

“Computing unit” may comprise processing means or computer processor such as a microprocessor, microcontroller, or their like, having one or more processing cores. Preferably, the computing unit receives one or more input signals from one or more sensors operatively connected with the machine. Accordingly, at least one of the signals is retrieved from the one or more sensors operatively connected with the machine. Alternatively, or in addition, the computing unit may control one or more actuators or switches operatively coupled to the machine. Accordingly, the computing unit may be able to manipulate one or more parameters related to the farming operation by controlling any one or more of the actuators or switches. The controlling is preferably done in response to the analysis of the one or more signals retrieved from the machine.

“Connectivity interface” refers to software and/or hardware interface for establishing communication such as transfer or exchange of signals or data. “Network interface” refers to a device or a group of one or more hardware and/or software components that allow an operative connection with a network. The communication may either be wired, or it may be wireless. Connectivity interface is preferably based on or it supports one or more communication protocols. The communication protocol may a wireless protocol, for example: short distance communication protocol such as Bluetooth®, or WiFi, or long communication protocol such as cellular or mobile network, for example, second-generation cellular network or (“2G”), 3G, 4G, Long-Term Evolution (“LTE”), or 5G. Alternatively, or in addition, the connectivity interface may even be based on a proprietary short distance or long distance protocol. The connectivity interface may support any one or more standards and/or proprietary protocols. Alternatively, or in addition, the connectivity interface may support any one or more wired communication protocols such as Controller Area Network (“CAN bus”), ISO 11783 or ISOBUS, J1939, or even a proprietary protocol. According to an aspect, the connectivity interface and the network interface are the same device or a shared group of components.

“Network” discussed herein may be any suitable kind of data transmission medium, wired, wireless, or their combination. A specific kind of network is not limiting to the scope or generality of the present teachings. The network can hence refer to any suitable arbitrary interconnection between at least one communication endpoint to another communication endpoint. Network may comprise one or more distribution points, routers or other types of communication hardware. The interconnection of the network may be formed by means of physically hard wiring, optical and/or wireless radio-frequency methods. The network specifically may be or may comprise a physical network fully or partially made by hardwiring, such as a fiber-optical network or a network fully or partially made by electrically conductive cables or a combination thereof. The network may at least partially comprise the internet.

“Remote server” refers to one or more computers or one or more computer servers that are located away from the farm or the geographical location. Preferably, the remote server is operated by a supplier of at least a part of the field specific data. The remote server may thus be located several kilometers or more from the geographical location. The remote server may even be located in a different country. The remote server may even be at least partially implemented as a cloud based service or platform. The term may even refer collectively to more that one computers or servers located on different locations. The remote server may be a data management system. The remote server may even be a field management system either as a different system or within the same system.

“Memory storage” refers to a device for storage of information, in the form of data, in a suitable storage medium. Preferably, the memory storage is a digital storage suitable for storing the information in a digital form which is machine-readable, for example digital data that are readable via a computer processor. The memory storage may thus be realized as a digital memory storage device that is readable by a computer processor. Further preferably, the memory storage on the digital memory storage device may also be manipulated via a computer processor. For example, any part of the data recorded on the digital memory storage device may be written and/or erased and/or overwritten, partially or wholly, with new data by the computer processor.

“Computer processor” refers to an arbitrary logic circuitry configured for performing basic operations of a computer or system, and/or, generally, to a device which is configured for performing calculations or logic operations. In particular, the processing means or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means or computer processor may be a multicore processor. Specifically, the processing means or computer processor may be or may comprise a Central Processing Unit (“CPU”). The processing means or computer processor may be a (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified.

“Geolocation module” may refer to any geolocation determining means such as a beacon and/or satellite navigation device based on any one or more technologies such as Global Positioning System (“GPS”), Global Navigation Satellite System (“GLONASS”), Galileo, or BeiDou. Alternatively, or in addition, geolocation module may also refer to a module, with hardware and/or software components, that can track or compute the location of the machine with respect to one or more reference points. For example, after calibrating the machine at one known reference point, the distance and direction traversed by the machine can be used to compute the location of the machine with respect to that reference point. This can be especially beneficial in indoor spaces where satellite based signals may not be accessible to calculate the location.

“Environmental sample” here refers to any kind of sample that is collected from the geographical location or the surrounding area, for example, for analysis such as detecting the presence of a harmful organism or pathogen. The environmental sample may or may not comprise a portion of the crop at the geographical location. The environmental sample may be collected from any one or a combination thereof of: air, water, inorganic or organic matter from the geographical location or crop site or field that comprises the geographical location. For example, the environmental sample may be a soil sample obtained from the geographical location or crop site, and/or it may be a foliage or other organic matter such as mulch, humus or composted matter. The environmental sample may even be pollen collected either directly from the crop or on-site from air. It will thus be appreciated that the environmental sample can be any one or more of the: whole plant, plant parts such as leaf, root, flower, pollen, soil samples, spore collections (e.g., on filter paper). A foliage or leaf sample may comprise a part of the crop, or it may just be a weed foliage or a weed plant part. When a sample is collected from air on-site, indicators of the organism such as spores, traces, etc. may be collected. In some cases, the sample may comprise an organism or microorganism, e.g., in the form of an insect or a part thereof. The environmental sample may to used to analyze any one or more of soil properties or measurements such as pH value, water hardness, mineral concentration, crop properties for example for determining crop health, presence of any one or more undesired features such as pathogens and presence of any one or more desired features such as favorable organisms or microorganisms.

According to an aspect, at least one of the one or more signals retrieved from the machine may be retrieved or received from one or more sensors operatively connected with the machine or communicatively coupled to the machine. According to an aspect, at least some of the sensors may be connected to the machine via at least one connectivity interface. Sensors connected to the machine may monitor the machine status prior and/or during performance or execution of the farming operation. Additionally or alternatively, sensors connected to the machine may monitor the conditions at the geographical location prior and/or during performance or execution of the farming operation. According to an aspect, at least some of the sensors may be associated with the geographical location and may be communicatively coupled to the machine or the computing unit via at least one network interface. Such sensors may monitor the conditions at the geographical location prior and/or during performance or execution of the farming operation.

Any of the signals can be continuous signals or they may be intermittent signals. Any of the signals may be analog- or digital-signals. For example, a continuous signal may be signal that represents a continuous measurement, which may be time-varying or time-constant. By time-varying, it is meant a signal comprising time varying data or information. In some cases, the continuous signal may even represent a time-constant signal, representing a time-constant or near time-constant measurement, such as a binary state, for example, state of a switch. The present teachings are not limited to a specific kind of sensor, but some examples of sensors that can be particularly useful in a farming operation are: imaging sensor such as a camera, weather sensors measuring weather parameters such as temperature, light, moisture, chemical- or bio-sensor such as a pH sensor, gas sensor or a lab-on-chip, gene sequencing sensor, physical sensor measuring one or more of physical parameters, such level, moisture, temperature, light, color, speed, force, pressure, distance and proximity.

In one example the signal retrieved from the machine may be a location signal such as a signal from a GPS module. In another example the signal retrieved from the machine may be a signal from the control system of the machine signifying the loading status of the farming operation parameters to the control system of the machine. In another example the signal retrieved from the machine may be a time. In another example the signal retrieved from the machine may by a sensor signal related to current weather conditions on the field. Such signal may be provided from sensors attached to the machine or situated in the field and communicatively coupled to the machine. In another example the signal from the machine may relate to the machine operation status. The signal may for instance signify tank fill levels, status of implements for framing operations or calibration status.

According to an aspect, the method further comprises:
receiving, via a network interface, field specific data and providing the field specific data to memory storage;

Hence, the field specific data may be provided at the memory storage, via the network interface operatively connected to the computing unit. The field specific data may be provided from a remote server, either upon request from the computing unit, or by initiative of the remote server. The field specific data may be downloaded, via at least one network to the network interface, from the remote server either directly or indirectly at the memory storage. For example, a download of the field specific data may be made at a computer and then the downloaded field specific data may be transferred to the memory storage. More preferably, the computing unit is able to communicate with the remote server for obtaining the field specific data at the memory storage.

If a version of field specific data is already available at the memory storage, the computing unit may check at regular or arbitrary time periods if a newer version of field specific data is available at the remote server. Alternatively, or in addition, the check for a newer version of the field specific data is triggered in response to a farming operation being planned or initiated, for example by the user planning or initiating a farming operation. By this way, it can be ensured that the most updated field specific data available at that time can be used for performing the farming operation, hence preventing wastage and/or improving safety of the farming operation to be conducted.

Alternatively, or in addition, the remote server may transmit a signal to the computing unit whenever a newer version of the field specific data is available. According to an aspect, the field specific data is provided at the memory storage such that the computing unit is able to validate and/or specify the farming operation without requiring an active connection to the remote server. This can have an advantage that the farming operation may be performed or conducted with the most updated field specific data available without requiring an uninterrupted connection to the remote server.

In one aspect, the field specific data relates to the machine and/or to the farming operation and/or validation data and/or one or more validation rules. The field specific data may include data related to the machine and/or to the farming operation. The field specific data may include validation data and/or one or more validation rules. The validation data and/or validation rules may relate to static or dynamic validation factors. The static validation factors may relate to the geographical location, such as the field, the farming operation to be performed or executed, the machine. The dynamic validation factors may relate to the geographical location, such as the field, the farming operation to be performed or executed, the machine.

This way the field specific data enables safe execution of the farming operation. By including data related to the machine and/or to the farming operation in connection with associated validation data and/or one or more validation rules the safe operation may be ensured. By including the data related to the machine and/or to the farming operation in connection with associated validation data and/or one or more validation rules in a field specific manner allows for field specific safety.

It will, hence, be understood that the field specific data comprise data from, or related to, or relevant to, the geographical location. The farming operation can thus be validated and/or specified according to the requirements of or the one or more parameters related to the geographical location. The one or more signals are preferably measured at the geographical location, hence, rather than specifying and/or validating exactly the same farming operation over the whole field, the computing unit can compute the requirements for the farming operation at each of the geographical locations within the field. This allows for more tailored and targeted farming operation decreasing the environmental effect and increasing the efficiency or efficacy of the farming operation. Hence, time and/or resources associated with conducting the farming operation can be reduced whilst achieving the goal of the farming operation. Accordingly, it can be avoided that the farming operation is overperformed in terms of consuming excessive resources and/or time at some or most of the geographical locations of the field. In cases where the farming operation comprises dissemination of at least one agricultural substance, wastage of the agricultural substance can be minimized. Environmental impact can thus be reduced. By integrating the computing unit with the machine, and further implementing the method steps, not only user friendliness can be achieved, but also sources of human error can be significantly reduced. Safety can thus be improved. Farming can also be made more accessible to new or unexperienced farmers.

Accordingly, the geographical location is preferably a part of the field. Further preferably, the field specific data include data from the geographical location.

According to an aspect, the field specific data include, or are derived from, terrestrial data and/or topographical data of the geographical location, for example, satellite data and/or aerial data. For example, field specific data may comprise data extracted from satellite and/or aerial imagery.

The field specific data may include, or are derived from, weather data, for example, forecast of any one or more of: temperature, humidity, precipitation, solar or ultraviolet (“UV”) radiation, wind speed, and wind direction, or any other weather related parameter.

Preferably, field specific data also include data related to one or more agricultural substances. For example, the field specific data may include data from a previous dissemination of one or more of the agricultural substances on the field and/or at the geographical location. Alternatively, or in addition, the field specific data may include data previously performed or conducted, one or more similar or dissimilar, farming operations on the field and/or at the geographical location.

The field specific data may also include usage data related to the agricultural substances, for example, active ingredients, chemical composition, usage modes and dosage.

Alternatively, or in addition, the field specific data include validation data and/or one or more validation rules for determining whether a certain farming operation may be conducted or not. As outlined above, a result of the determination may be communicated for the user via the output signal to the Human Machine Interface (“HMI”). Said validation data and/or one or more validation rules may for example be provided as a computer logic data or computer instructions for the computing unit. Hence, the field specific data may at least partially include computer control logic data for validating one or more farming operations. The control logic may for example, be used for specifying and/or validating dissemination of any one or more of the agricultural substances. The control logic may hence enable the computing unit to validate the selected farming operation as a suitable farming operation, if the selected farming operation is safe and it may be conducted, e.g., in view of the current conditions at the geographical location. Accordingly, the dissemination of the any one or more of the agricultural substances may also be conducted and/or controlled according to the control logic. The control logic may be executed via the computing unit for validating or specifying the farming operation. Preferably, the control logic is used for controlling the farming operation in response to the analysis of the one or more signals retrieved from the machine. Hence the farming operation such as dissemination may be conducted more safely and according to the specific conditions at the geographical location. Moreover, the farming operation can be conducted more suitably at the geographical location, for example, by considering previous one or more farming operations such as dissemination of agricultural substances on the field along with the present conditions at the geographical location and/or the field.

The validation rules may relate to, or they may include, a static validation that includes one or more checks that are specific to the farming operation. For example, the farming operation specific validation may include checking any one or more of that: the field specific data are applicable to the geographical location, the field specific data are of the requisite version, timing restriction for an allowable farming operation is met, one or more of the agricultural substances if required are allowable, and weather conditions if relevant are acceptable.

Additionally, or alternatively, the static validation may include performing, via the computing unit, one or more determinations or checks that are specific to the hardware related to the machine and/or the farming operation. For example, the hardware specific validation may include determining or checking any one or more of that: the one or more sensors are operational and provide a valid output, e.g., calibrated and/or plausible, if applicable any actuators and/or end effector units are operational and/or their calibration is valid, if applicable the quantity or amount of any one or more of the agricultural substances is sufficient, for example, the fill level of tank containing the agricultural substance is sufficient for a planned dissemination.

The static validation may be understood of as a validation operation performed under static or near static conditions of the machine, for example, prior to start of the farming operation. The static validation can thus be used for initial stage of a farming operation, or if the farming operation is to be altered. When static validation is concluded, dependent upon the determination, the computing unit may either indicate via the output signal to the HMI that the farming operation may be initiated, or the computing unit may automatically operate or control the machine such that the farming operation is initiated. Alternatively, should the determination be negative, the computing unit may indicate via the output signal to the HMI that the farming operation should not be initiated. According to an aspect, the negative determinations are provided with different responses from the computing unit. As a non-limiting example, the determination may be a critical determination, which is associated with a substantially undesired outcome, for example, an unsafe outcome and/or loss to environment or resources. The critical determination may be recognizable through a different response, for example, an enhanced HMI response and/or the computing unit preventing the machine from initiating the farming operation. Alternatively, other negative determination(s) may be a non-critical determination, which is associated with a relatively minor undesired outcome as compared to the critical determination, for example, an outcome with reduced efficacy of the farming operation. The non-critical determination may be recognizable through a response different from the response to the critical determination, for example, a different HMI response or warning and/or the computing unit preventing the machine from initiating the farming operation in an overridable manner. The non-critical determination or warning may be possible to be overridden by the user, while the critical determination may not be overridable by the user, or it may require one or more additional approvals for overriding from a different user or the service provider. So, a prevented farming operation may be overridable by the user.

Additionally, or alternatively, the validation rules may relate to, or they may include, a dynamic validation that relates to one or more checks or determinations that are performed during the time when the machine is being used during the farming operation being conducted. The dynamic validation may be carried out once at each geographical location, or it may be done multiple times at one or more geographical locations. In some cases, or at some or all geographical locations, the dynamic validation may be performed continuously or intermittently. The farming operation may either be conducted via the machine, or it may be assisted by the machine. Any of the one or more signals can be analyzed and thus at least partially from the signals, data related to the farming operation and/or the machine itself and/or the geographical location or the field can be used to continuously or intermittently validate the farming operation. For example, data such as weather data and/or machine data (e.g. Any one or more of: speed, pressure related to the nozzle system that is used for dissemination such as spraying, dissemination rate, remaining agricultural substance, present position, time, fuel consumption) and/or other data available from the machine during operation in the field and/or from any in-field sensors and/or in case where server connectivity is available, data from the remote server. The dynamic validation may include a tailored or specific set of validation parameters relevant for the farming operation being conducted. The dynamic validation parameters may include ranges such as temperature range. For example, if the temperature at the geographical location or on the field rises to a value higher than a temperature range, the validation instructions may lead to a respective warning signal being triggered by the computing unit. The warning signal may be used to display at the HMI and/or it may control an operation of the machine. Moreover, any given range may be associated with a different range. For example, an acceptable temperature range may be associated with a certain time period in a day. Additionally or alternatively, if for example, the wind speed at the location or in the field increases over a certain value or range at or within a certain period of time, the dynamic validation may lead to a respective warning triggered by the computing unit and/or an operation of the machine may be controlled in response. It can thus be ensured that the farming operation is dynamically validated and/or conducted and/or controlled for safety and/or efficiency in response to the ever changing conditions at the geographical location.

The dynamic warnings may be clustered in line with the static validation warnings and may trigger active confirmation screens for the user.

Alternatively, or in addition, the control logic comprises data for determining one or more unsuitable parameters for the farming operation, Accordingly, the computing unit is able to determine ways in which the farming operation should not be conducted. The determination of unsuitable ways of conducting the farming operation is preferably performed in response to the analysis of the one or more signals retrieved from the machine. For example, by doing so the computing unit may determine that a given concentration of the agricultural substance should not be used at the current temperature measured and/or the wind speed and/or direction at the geographical location. The control logic may also be used to perform the static validation and/or the dynamic validation.

In one aspect, the acceptability determination is triggered based on an operation activation signal from the machine. Such activation signal may be provided from the machine to the computing unit prior to execution of the farming operation. The acceptability may be determined prior to execution of the farming operation. Additionally or alternatively, the acceptability may be determined during execution of the farming operation. In such a way the acceptability may not only be checked on start of the farming operation, but also while the operation is conducted. Particularly for large fields the field conditions may change during execution of the farming operations. This way such changes can be accounted for to increase reliability of the farming operation.

The acceptability criteria for the range or value of each of the parameters is defined by the field specific data. Accordingly, for each of the parameters being evaluated by the computing unit, a corresponding acceptable value or value range is provided via the field specific data, the corresponding value or range being usable by the computing unit to determine whether the parameters are acceptable for the farming operation or not.

Additionally, or alternatively, the parameters may be used for specifying a farming operation that is acceptable or suitable for the parameters as analyzed or provided via the one or more signals.

The determination of the acceptability may be done by processing, e.g., by applying any one or more suitable signal processing techniques such as analyzing by filtering and/or comparing and/or correlating, any one or more of the signals, in terms of their one or more signal values, to their respective reference and/or threshold values and/or signal value range specified by the field specific data. The acceptability criteria may be based on comparison of signal and/or parameter values with their respective threshold values. There may be one or more threshold values per any of the signals and/or parameters. For example, for an acceptable range, there may be a low threshold value and a high threshold value. In some cases, there may even be one or more intermediate threshold values within the range that may be associated with-, or usable for making-, specific determination(s) via the computing unit. The acceptability criteria is preferably dynamic in the terms that it may change from one set of field specific data to another field specific data even for the same geographical location for taking into account the specific requirements and/or conditions at the geographical location at a given time.

The farming operation can thus be adapted to the conditions specific to the geographical location, for example, in response to: recent crop properties and/or the parameters of one or more of the previous farming operations related to the geographical location and/or the outcome of any one or more of the previous farming operations and/or measurements related to the geographical location performed prior-to or around the time of performing the farming operation. At least some of the measurements are preferably performed via the one or more sensors. In some cases, the computing unit may determine that the farming operation may not be conducted on any one or more of the geographical locations, while it is conducted on the other locations. The farming operation can thus be prevented where it is not needed, or where it is not allowed. In cases where the machine is fully autonomous, the farming operation can be conducted or steered fully controlled via the computing unit. If the crop is present on the geographical location, then at least one of the sensors may be used to measure or detect properties of the crop and then adapt the farming operation according to the field specific data. The crop properties may for example be: crop length such as plant length or animal or organism length, color, greenness, crop density, crop biomass, crop species, thickness, presence detection, or any property that can be detected or measured using a sensor.

For the above examples of signals retrieved from the machine, the determining if any one or more of the parameters related to the machine and/or to the farming operation lie within an acceptable range or value specified using or by field specific data, may include machine and/or farming operation

The location signal such as the signal from a GPS module may be on parameter retrieved from the machine. The location parameter may be used to determine, if the farming operation parameters provided through the field specific data are associated with such location. The loading status of the farming operation parameters to the control system of the machine may be used to determine, if the farming operation parameters provided by the field specific data are loaded successfully. This way is can be ensured that the data required for monitoring and/or controlling the machine is available to the machine. The time of the machine may be checked to lie within a time slot provided by the field specific data for executing the farming operation. The current weather conditions on the field may be checked to lie within the range of weather conditions provided by the field specific data for executing the farming operation. The machine operation status may be used to check tank fill levels are sufficient, the status of implements or the calibration status may be used to check the implements are operational.

For example, the output signal generated by the computing unit may perform a task i.e., validate and/or specify, or it may even be used for conducting or executing the farming operation. Additionally, or alternatively, the task may be performed based on analysis from one or more environmental samples at or around the geographical location. Additionally, or alternatively, the task may be performed, for example, based on the concentration of an agricultural substance that was disseminated previously at the geographical location.

According to an aspect, the computing unit is operatively coupled to a Human Machine Interface (“HMI”). The HMI may comprise at least one display device and/or at least one audio device. The display device may be any one or more of: an visual indicator or a display screen. The audio device may be any one or more of: an annunciator or a loudspeaker. Any one or more determinations or results may be communicated for the user via the HMI, for example, the output signal may be provided either directly or indirectly to the HMI. Additionally, the HMI may also be used to communicate any of the one or more signals retrieved from the machine and/or any of the one or more parameters, either visually and/or audibly. Additionally, the HMI may also be used to display the geographical location and/or any relevant parameters related to the computing unit and/or any one or more parameters or values related to the farming operation.

According to an aspect, one or more failed static validation checks may be flagged as an unsuitable farming operation. The operator or user of the machine may be informed about such failed validation checks via the Human Machine Interface (“HMI”) operatively coupled to the computing unit. According to an aspect, the user is communicated and/or notified via the HMI about possible one or more ramification parameters associated with the unsuitable farming operation. The ramification parameters may be any one of more of, suboptimal efficacy of the farming operation, loss of yield of crop, or loss of warranty. The user can thus be prevented from making mistakes that can result in a poor result of the farming operation. More preferably, the machine is prevented from conducting an unsuitable farming operation. Hence, at least unintentional mistakes in selecting an unsuitable farming operation may be reduced or eliminated. Farming can thus be made more user friendly and safe. Alternatively, in cases where one or more failed static validation checks relate to a less serious scenario, for example reduced effectiveness of the farming operation, the HMI may be used to communicate the quality, or reduction thereof, which may be expected should the user decide to pursue the farming operation anyway.

Alternatively, or in addition, one or more failed dynamic validation checks may be flagged as an unsuitable farming operation. According to an aspect, in response to a failed dynamic validation at any geographical location the farming operation at that geographical location is prevented from being conducted. A warning may be issued via the HMI.

According to an aspect, the user of the machine may be able to override the prevention of the unsuitable farming operation. When a prevented or unsuitable farming operation is overridden, or if the user decides to proceed with conducting the farming operation with reduced effectiveness or in response to the non-critical determination, an exception signal is recorded by the computing unit at the memory storage operatively coupled to the computing unit and/or the exception signal is transmitted to a remote server. The exception signal may be transmitted, via any of the at least one network, directly to the remote server, or it may be transmitted later, for example when a communicative connection, via any of the at least one network, to the remote server is established or reestablished. The exception signal preferably includes data related to the override operation, for example one or more of the signals and/or parameters and/or data from the computing unit and/or the geographical location data.

Additionally, or alternatively, the control logic may comprise computer instructions enabling the computing unit to generate an alternative farming operation or a similar farming operation with different characteristics such that the alternative farming operation or the similar farming operation is a suitable farming operation.

According to an aspect, in response to the validation, the computing unit provides recommendation via the HMI for adjusting the parameters of the farming operation which can improve the farming operation according to the conditions at or around the geographical location. For example, the recommendation may be to reduce the speed of the machine to a given value. This recommendation may have been triggered by a wind speed increase measured via the sensors. Preferably, the machine is automatically controlled by the computing unit to adapt according to the conditions in-field or at the geographical location such that a suitable or optimal farming operation is conducted at the geographical location.

Further additionally, or alternatively, the field specific data may comprise data defining any one or more of: computerized map of the field including data related to the agricultural substance, which data may specify dissemination parameters for the agricultural substance at a plurality of geographical locations within the field. The computerized map may, for example, include dissemination rules or criteria for one or more geographical locations. The dissemination can thus be adapted to the conditions specific to the geographical location, for example, in response to: the parameters of one or more of the previous farming operations related to the geographical location and/or the outcome of any one or more of the previous farming operations and/or measurements related to the geographical location performed prior-to or around the time of performing or conducting the farming operation. The measurements are preferably performed via the one or more sensors. In some cases, the dissemination may not be conducted on any one or more of the geographical locations, while it is conducted on the other locations. The dissemination can thus be prevented where it is not needed, or where it is not allowed. In cases where the machine is fully autonomous, the dissemination can be conducted fully controlled via the computing unit.

Also additionally, or alternatively, the field specific data may comprise data, which define one or more timing slots for conducting one or more of the farming operations. Such timing slots may relate to times when the farming operation may be preferably conducted, and/or times when the farming operation preferably should not be conducted and/or if the farming operation should not be conducted at all.

Further additionally, or alternatively, the field specific data may comprise data, which define one or more distance requirements for conducting the farming operation. Such requirements may either be due to safety, environmental or legal reasons.

Further additionally, or alternatively, the field specific data may even comprise data, which define selection criteria or logic for determining a suitable agricultural substance for the prevailing conditions on the geographical location or field. Accordingly, a suitable product recommendation can be made or selected according to the requirements of the site and according to the current conditions.

Further additionally, or alternatively, the field specific data may be an immutable set of data defined at a certain point, for example, at a time when the farming operation is planned. Further additionally, or alternatively, the field specific data are, or comprise, a snapshot of the state, at a given time, of the field comprising the geographical location.

Further additionally, or alternatively, the field specific data are provided with an expiry date. By the term expiry date, it will be understood such a time limit for the validity of the field specific data that the computing unit is prevented to use the field specific data at a date which is beyond the expiry date specified for that field specific data.

Further additionally, or alternatively, the field specific data may comprise data, which define operating or driving patterns and/or instructions for the machine.

Preferably, the field specific data comprises data, which define fall back parameters or safe mode data which prevent an unsuitable farming operation from being performed or conducted even if an updated field specific data cannot be provided or is unavailable.

The field specific data may also comprise data, which define information on severity of consequence in case of a violation, for example associated with conducting the unsuitable farming operation. The information may be provided to the user, for example, for preventing unintentional or intentional overriding of the prevention of the unsuitable farming operation.

In some cases, the field specific data may be manipulated by or may comprise input data provided by the user. Such inputs may for example be data related to user preferences and/or it may be related to more specific information regarding the farming operation that may be usable by the computing unit.

According to an aspect, the computing unit is operatively coupled to a geolocation module for obtaining at least one geolocation parameter. The geolocation module is preferably attached to, or the geolocation module by any other means tracks, the machine such that the location of the machine is determined continuously or intermittently. Accordingly, the computing unit is able to determine the current location of the machine. The geolocation parameter may be in the form of a signal that can provide an absolute and/or relative position or location on Earth or elsewhere. For example, the at least one geolocation parameter may indicate coordinates of the location of the machine, and/or it may indicate a relative distance from two or more reference points. By determining the current location of the machine, the computing unit can better validate and/or specify and/or control the farming operation such that the farming operation is performed or conducted in such a way that it is more suitable for the geographical location.

The output signal may directly indicate whether the planned farming operation may be conducted or not, and/or it may be usable by the computing unit in a more autonomous manner for validating the feasibility of one or more farming operations that are being envisaged. As a direct output, the output signal may be used for informing a user via the HMI whether the farming operation may be conducted. The output signal may also be used for informing a user via the HMI whether the farming operation may not be conducted. According to an aspect, in generating the output signal, the computing unit may also check that the machine is sufficiently equipped for conducting the farming operation, for example via the static validation as previously discussed. This can further improve the effectiveness of the machine and farming operation by reducing requirement to drive away from the field to replenish the resources required for conducting the farming operation.

In one aspect, the output signal may include data specifying the farming operation, a user confirmation for executing the farming operation, a warning and/or an user overridable signal to prevent farming operation. The output may trigger confirmation to user prior to start of operation. The output signal may provide one or more instructions to be validated or selected by user. The output signal may provide a warning to user. The output signal may provide an option to overwrite the validation data. Such way farming operation may be enforced.

According to an aspect, the machine may be provided essentially fully equipped at least in terms of hardware components required for specifying and/or validating the farming operation. In such a case, the computing unit may be an in-built unit in the machine. Accordingly, the machine may come preinstalled with the computing unit, the memory storage, the connectivity interface and the network interface. Accordingly, the field specific data may be provided directly to the machine, e.g., via the preinstalled network interface. Additionally, the machine may also come preinstalled with hardware and, if required software, for providing the one or more signal to the computing unit. According to an aspect, the machine may also come preinstalled with the HMI. According to an aspect, the machine may also come preinstalled with the one or more sensors operatively connected with the machine, at least some of the sensors being operatively connected to the connectivity interface. Ideally, the machine comes preinstalled with all sensors required for the farming operation, even all kinds of farming operations required on the field. Hence, ideally, the machine may be provided essentially fully equipped at least in terms of hardware components required for conducting the farming operation. Thus, according to an aspect, the machine may also come preinstalled with the one or more actuators and/or end effector units operatively connected with the machine, at least some of the actuators and/or end effector units being operatively connected to the connectivity interface. Ideally, the machine comes preinstalled with all sensors, actuators or end effector units required for the farming operation, even all kinds of farming operations required on the field. According to an aspect, the machine may be granted access to the field specific data as a service, for example, as Software as a Service (“SaaS”) or Platform as a Service (“PaaS”).

“Actuator” refers to any component of that is responsible for moving and controlling a mechanism related to the machine and/or for controlling the farming operation directly or indirectly. The actuator may be a valve, motor, a drive, or their likes. The actuator may be operable electrically, hydraulically, pneumatically, or any of their combination.

“End effector unit” or “end effector” in this context refers to device operatively connected to the machine, controllable via the computing unit, with a purpose to interact with the environment around the machine. For example, the end effector may be a cutter, gripper, sprayer, seeder, tiller, or their likes, or even their respective parts that are designed to interact with the environment. The environment in this context may be earth or soil, water, anything lying on the ground, or the crop itself around the machine's location preferably where the farming operation is envisaged.

Optionally, the computing unit may be in the form of a mobile device comprising the memory storage, such as a smartphone, tablet, a suitable smart wearable device, that is used for accessing the field specific data and for validating and/or specifying the farming operation. The connectivity interface may be split between the machine and the mobile device, for example, the mobile device may comprise a device connectivity interface and the machine may be provided with a machine connectivity interface. The device connectivity interface may be communicatively connected to the machine connectivity interface when the machine is operatively coupled to a computing unit, for example prior to performing or conducting the farming operation. The communicative connection between the device connectivity interface and the machine connectivity interface may either be wired, or it may be wireless. Accordingly, the mobile device may, for example, be docked via a docking socket or station in the machine, or it may be connected via a connector. Alternatively, or in addition, the mobile device may operatively connect via the device connectivity interface and the machine connectivity interface to the machine using any suitable wireless protocol such as Bluetooth®, WiFi, any mobile or cellular network protocol, or any standard or proprietary protocol. For machines which do not come preinstalled with any or sufficient hardware required for implementing the proposed teachings, additional hardware such as sensors may be retrofitted. Additionally, preferably, one or more actuators and/or end effector units may be installed, for example, for at least partially manipulating or controlling the farming operation via the computing unit. It will be understood that the one or more actuators/or end effector units may be operatively connectable to the computing unit via the connectivity interface. The additional hardware may or may not comprise computer logic or user downloadable computer instructions. In a simple sense, the additional hardware may just be a gateway for the mobile device to the machine. Accordingly, most or all of the logical functions such as validating, specifying, and control may be performed via the mobile device. The additional hardware may be connected via a wired connection which may be similar to as outlined for the connectivity interface. For example, the wired connection may be CAN BUS based and use standardized protocols such as ISOBUS and J1939. It will be appreciated that the wired connection may lead to the machine connectivity interface, which may then be used to communicatively engage with the device connectivity interface. A serial or other connections and/or proprietary protocols can also be used for the wired connection. The mobile device may either be supplied by a supplier, or it may be a standard mobile device with installed software or at least one application that is granted access to the field specific data as a service, for example, as SaaS or PaaS. The network interface may be a part of the mobile device, or the mobile device may comprise a device network interface. Additionally, or alternatively, the machine may be provided with a machine network interface. For example, the mobile device may use the machine network interface when the machine is operatively coupled to the mobile device. The mobile device may also comprise at least one display element and/or at least one audio element. According to an aspect, any of the at least one display element and/or at least one audio element is used as the HMI. In other words, the HMI may at least partially be a part of the mobile device.

Since not all agricultural machines may be equipped with requisite hardware, the option with the computing unit in the form of a mobile device can provide the user better flexibility in selecting a suitable machine and then adapting it for implementing the present teachings. The requisite hardware and software may be provided in the form of one or more kits for implementing the present teachings via such machines.

Those skilled in the art shall appreciate that any suitable intermediate combination of the above two approaches may also be possible. For example, the computing unit may be split between a machine computing unit and a mobile computing unit. Additionally, or alternatively, the memory storage may be a part of the either computing units, or it may be a separate unit, for example a pluggable memory storage that can be operatively connected to either of the computing units. In some cases, the memory storage may even be split between either of the computing units, either as pluggable element or a fixed one. Similarly, some or all additional sensors may be provided. Accordingly, in cases of machines that are not fully equipped, an upgrade may be performed with required additional hardware and/or software in the form of one or more kits for implementing the present teachings.

According to an aspect, the computing unit may provide update data at the memory storage and/or at the remote server. The update data may be provided via the memory storage or it may be provided by transmitting the update data directly to the remote server. Alternatively, or additionally, the update data may be provided to a second remote server that is different from the remote server. For simplicity and while preserving generality of the present teachings, by saying that “the update data is provided at the remote server”, the fact that the update data can be provided to a different server other than the remote server is also deemed falling within the ambit of these terms. The update data may comprise any of the one or more signals and/or any of the one or more parameters related to the geographical location, and/or the validation and/or specification of the farming operation at the geographical location. Additionally, or alternatively, update data may comprise data related to the farming operation conducted at the geographical location. The update data may also include the exception signal. At least in response to the one or more signals and/or the one or more parameters related to the geographical location included in the update data, e.g., by analyzing the update data, the remote server may generate new field specific data or updated field specific data that may be provided to the computing unit at a later time. The new field specific data may be used for specifying and/or validating, or conducting a future farming operation at the geographical location. According to another aspect, the update data is used for training a machine learning (“ML”) module for improving recommendations and actions for future farming operations. Especially when the exception signal is provided, said training can be made more reliable and robust towards data manipulation which may occur if an unsuitable farming operation were conducted by overriding the determination of the computing unit. Badly trained models can have far reaching effects also to other farms also where the supplier provides field specific data using at least in-part models trained from the data comprising unsuitable data. Safety and reliability of farming operations can thus be significantly improved. Furthermore, data from the exception signal can be used to generate the new field specific data such that the impact of overriding, i.e., conducting an unsuitable farming operation at the geographical location, can be at least minimized, and preferably eliminated. A future farming operation at the geographical location can thus take into account the deviation caused by the unsuitable farming operation and try to at least partially neutralize the undesired effect thereof via the new field specific data. This can make the farming operations more robust and flexible to undesired effects. It will further be appreciated that the advantage is not limited only to the exception signal. For example, if a previously conducted farming operation were not an unsuitable farming operation, however in retrospect it is deemed to be a sub-optimal one, the field specific data can be adapted such that the farming operation can be adapted such that any undesired effect of the sub-optimal farming operation is at least partially neutralized.

Those skilled in the art will appreciate that the method steps, at least those which are performed via the computing unit may be performed in a “real-time” or near real-time manner. The terms are understood in the technical field of computers. As a specific example, a time delay between any two steps performed by the computing unit is no more than 15 s, specifically of no more than 10 s, more specifically of no more than 5 s. Preferably, the delay is less than a second, more preferably, less than a couple of milliseconds.

When viewed from another perspective, there can also be provided a farming machine, an agricultural machine, or a machine for performing an agricultural farming operation, the machine being configured to perform the method herein disclosed.

For example, there can be provided a machine for performing an agricultural farming operation at a geographical location, the machine being operatively coupled to a computing unit, and the computing unit being operatively a memory storage, the machine being adapted such that the computing unit is configured to:
analyze one or more signals retrieved from the machine; the one or more signals being indicative of one or more parameters related to the machine and/or to the farming operation;
determine whether any one or more of the parameters lie within an acceptable range or value, which range or value is specified using field specific data that are provided at the memory storage; and
generate an output signal in response to the determination; wherein the output signal is usable for validating and/or specifying the farming operation.

When viewed from another perspective, there can also be provided a computer program comprising instructions which, when the program is executed by a suitable computing unit, cause the computing unit to carry out the method steps herein disclosed. There can also be provided a non-transitory computer readable medium storing a program causing a suitable computing unit to execute any method steps herein disclosed.

For example, there can be provided a computer program, or a non-transitory computer readable medium storing the program, comprising instructions which, when the program is executed by a suitable computing unit operatively coupled to: a memory storage, and a machine for performing an agricultural farming operation at a geographical location, causes the computing unit to:
analyze one or more signals retrieved from the machine; the one or more signals being indicative of one or more parameters related to the machine and/or to the farming operation;
determine whether any one or more of the parameters lie within an acceptable range or value, which range or value is specified using field specific data that are provided at the memory storage; and
generate an output signal in response to the determination;
wherein the output signal is usable for validating and/or specifying the farming operation.

A computer-readable data medium or carrier includes any suitable data storage device on which is stored one or more sets of instructions (e.g., software) embodying any one or more of the methodologies or functions described herein. The instructions may also reside, completely or at least partially, within the main memory and/or within the processor during execution thereof by the computing unit, main memory, and processing device, which may constitute computer-readable storage media. The instructions may further be transmitted or received over a network via a network interface device.

The computer program for implementing one or more of the embodiments described herein may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network.

Furthermore, a data carrier or a data storage medium for making a computer program product available for downloading can be also provided, which computer program product is arranged to perform a method according to any of the aspects herein disclosed.

When viewed from another perspective, there can also be provided a computing unit comprising the computer program code for carrying out the method herein disclosed. Also, there can be provided a computing unit operatively coupled to a memory storage comprising the computer program code for carrying out the method herein disclosed.

### BRIEF DESCRIPTION OF THE SEVERAL VIEWS OF THE DRAWINGS

Certain aspects of the present teachings will now be discussed with reference to the following drawings that explain the said aspects by the way of examples. Since the generality of the present teachings is not dependent on it, the drawings may not drawn to scale. Certain features shown in the drawings can be logical features that are shown together with physical features for sake of understanding and without affecting the generality of the present teachings. To easily identify the discussion of any particular element or act, the most significant digit or digits in a reference number refer to the figure number in which that element is first introduced.

FIG. 1 illustrates a machine in accordance with certain aspects of the present teachings.

FIG. 2 illustrates an aspect of the present teachings with the machine in combination with or the machine being a sprayer.

FIG. 3 illustrates more detailed aspects of the sprayer.

FIG. 4 illustrates a flow-chart in accordance with the present teachings.

FIG. 5 illustrates an embodiment of a validation device for validating agricultural farming operations.

FIG. 6 illustrates an embodiment of the method for validating the agricultural farming operation prior to and/or during execution of the agricultural farming operation.

FIGS. 7a to c illustrates different configurations of the validation device for validating agricultural farming operations.

FIG. 8 illustrates an example of a data flow between different components of the distributed computing system of FIG. 1.

FIG. 9 illustrates the headers of example data packages that may be exchanged.

### DETAILED DESCRIPTION

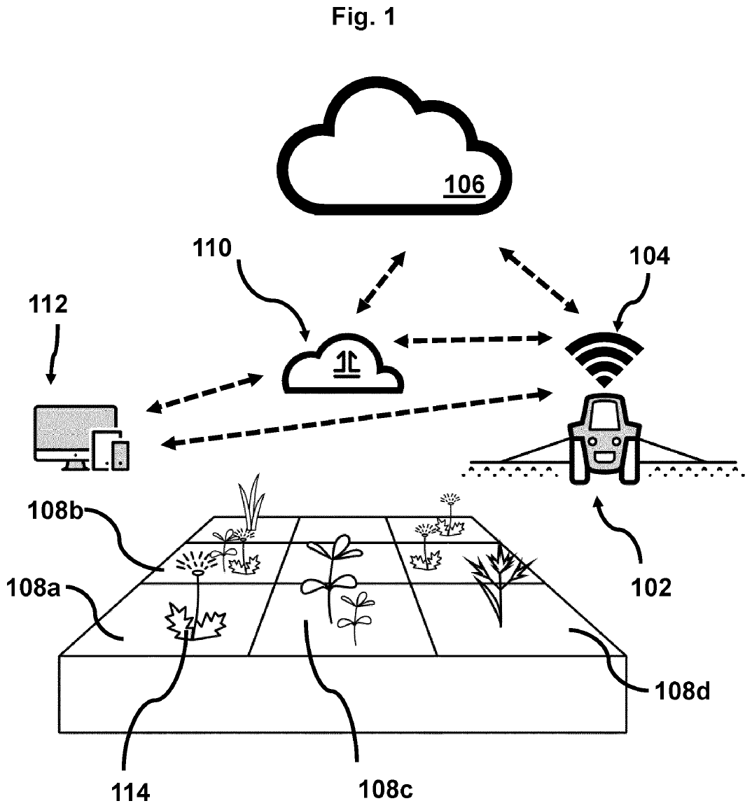

FIG. 1 illustrates a machine 102 shown here as part of a distributed computing environment. The machine 102 is used for performing and/or conducting an agricultural farming operation on a field which comprises a plurality of geographical locations 108. The farming operation may be a treatment for a crop which comprises a crop plant 114 located at a first geographical location 108a. The farming operation may even relate to a control or eradication of weed plants.

The machine 102 may be a smart sprayer and it may include a connectivity interface 104. The connectivity interface 104 may either be a part of a network interface, or it may be separate unit. In this drawing for simplicity it is assumed that the connectivity interface 104 and the network interface are the same unit. The connectivity interface 104 is operatively coupled to a computing unit (not shown explicitly in FIG. 1). The computing unit is operatively connectable to the machine 102. The connectivity interface 104 is configured to communicatively couple the machine 102 to the distributed computing environment. The connectivity interface 104 can be configured to provide field specific data at the computing unit. Moreover, the connectivity interface 104 can also be configured to provide update data, for example collected at the machine 102 to any one or more remote computing resources 106, 110, 112 of the distributed computing environment. Any one or more of the computing resources 106, 110, 112 may be a remote server 106, which can be a data management system configured to send data to the machine 102 or to receive data from the machine 102. For example, as detected maps or as farming operation maps comprising update data recorded during the farming operation on a geographical location 108a may be sent from the machine 102 to the remote server 106, shown in this example as a cloud based service. Any one or more of the computing resources 106, 110, 112 may be a field management system 110 that may be configured to provide a control protocol, an activation code or a decision logic, or in general field specific data, to the machine 102 or to receive data, for example, update data, from the machine 102. Alternatively, or in addition, such data may be received by the field management system 110 via the remote server 106 or data management system. Any one or more of the computing resources 106, 110, 112 may be a client computer 112 that may be configured to receive client data from the field management system 110 and/or the machine 102. Such client data may include for instance farming operation schedule to be conducted on one or more fields or on the plurality of geographical locations 108 with the machine or field analysis data to provide insights into the health state of certain one or more geographical locations or field. The client computer 112 may also refer to a plurality of devices, for example a desktop computer and/or one or more mobile devices such as a smartphone and/or a tablet and/or a smart wearable device. The machine 102 may be at least partially equipped with the computing unit, or the computing unit may be a mobile device that can be connected to the machine, via the connectivity interface 104. It will be appreciated that the field management system 110 and the remote server 106 may be the same unit. The computing unit may receive the field specific data either via the client computer 112, or it may receive it directly from the remote server 106 or the field management system 110.

In particular when data such as update data is recorded by the machine 102, such data may be distributed to any one or more of the computing resources 106, 110, 112 of the distributed computing environment.

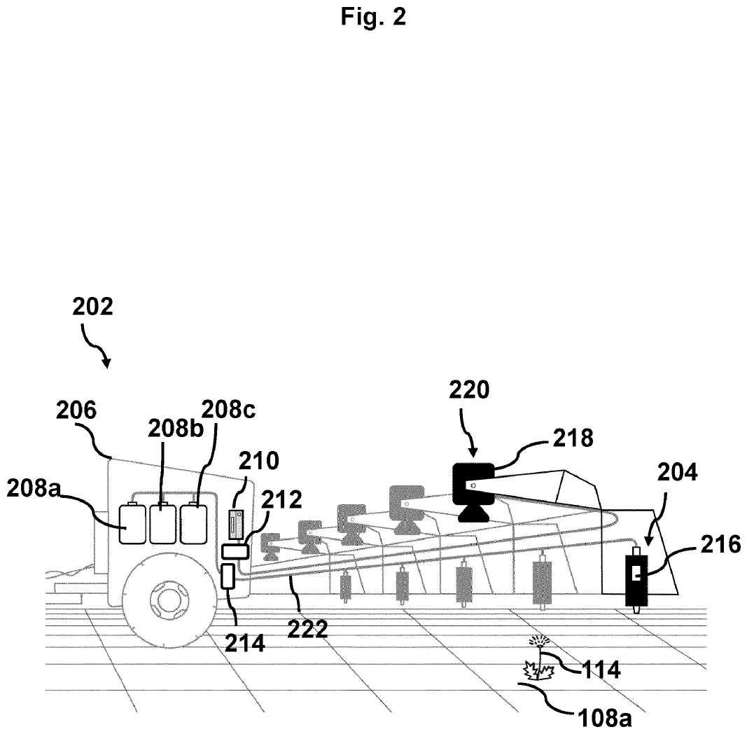

Now including reference to FIG. 2, the machine 102 may for instance include a spray device 202 including a monitoring system 212 for monitoring dissemination, for example, spray application of one or more agricultural substances. In one example, monitoring of one or more spray nozzles 204 may be done via one or more sensors, for example, sensor 214 and sensor 216. The sensors 214, 216 may be built into the fluidic system of the spray device 202. Such sensors 214, 216 are preferably placed in the common fluidic line 222 of a subset of spray nozzles 204, or for all spray nozzles 204. Together with one or more activation signals for controlling valves of the spray nozzles 204 and/or their associated tank(s), the machine 102 or spray device 202 has sufficient information to determine, e.g.:
1. deviations of the measured fluid property from the expected fluid property, and/or
2. a spray nozzle specific fluid property, and/or
3. a fluid property as measured by the sensor in the fluidic line, and/or
4. a spray nozzle position causing deviations.

Any such data, for example, the update data, may be recorded during the farming operation and transferred to e.g. the remote server 106 in real-time during the farming operation or spraying, and/or the data may be transferred after the farming operation is conducted. The latter may be the case for example if a network connection for transferring the data is not available during the farming operation. Based on update data any suboptimal or unsuitable farming operation conducted on the agricultural area or one or more geographical locations 108 may be analyzed.

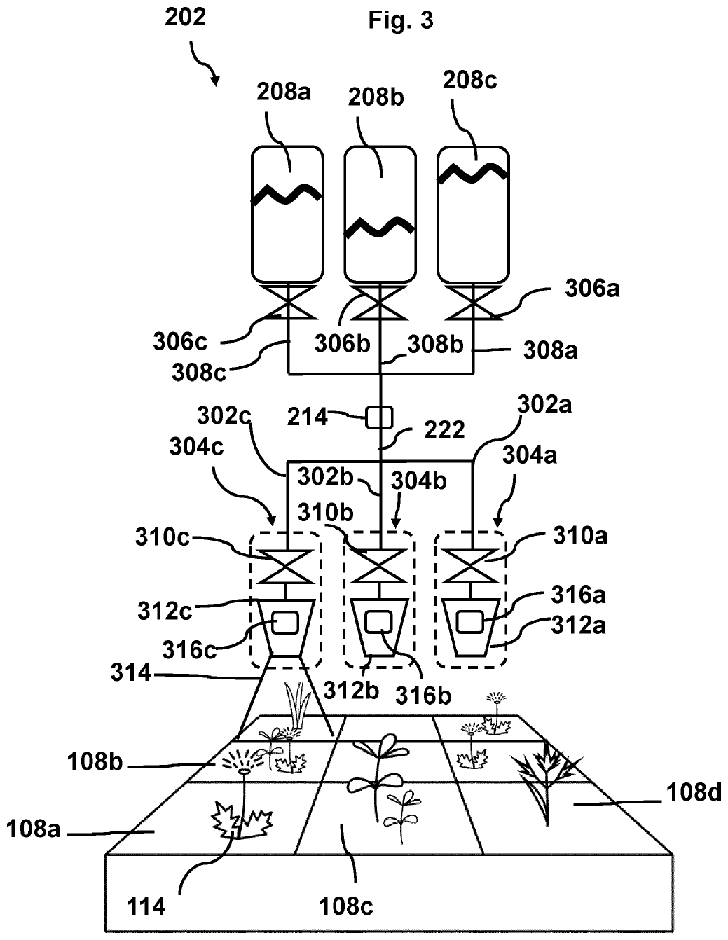

FIG. 2 shows further a non-limiting example of the spray device 202, and FIG. 3 shows a more detailed example of the spray device 202. For the sake of clarity FIGS. 2 and 3 are principle sketches, where the core elements are illustrated. In particular, the fluidic set up shown is a principle sketch and may comprise more components, such as dosing or feed pumps, mixing units, buffer tanks or volumes, distributed line feeds from multiple tanks, back flow, cyclic recovery or cleaning arrangements, different types of valves like check valves, ½ or ⅔ way valves and so on. Also, different fluidic set ups and mixing arrangements may be chosen. The teachings related to this example are, however, applicable to all dissemination setups, which have at least one common fluidic line serving a subset of spray nozzles or all spray nozzles with one or more fluids. Moreover, it will be appreciated that dissemination of one or more agricultural substances is non-limiting to the generality of the present teachings, as the teachings may be applied also to farming operations that do not involve a dissemination. Further moreover, those skilled in the art will realize that other farming operations such as aquatic farming operations being conducted via a suitable machine operatively connected to a computing unit pursuant to the present teachings are also possible as outlined in the present disclosure.

The machine 102 of FIGS. 2 and 3 may comprise a tractor (not shown) operatively attached or mounted with a spray device 202 for disseminating an agricultural substance, for example application of a pesticide, a herbicide, a fungicide or an insecticide on the geographical location 108a. The spray device 202 may be releasably attached or directly mounted to the tractor. The spray device 202 comprises a boom with one or more spray nozzles 204 arranged along the boom of the spray device 202. In FIG. 3, a plurality of such spray nozzles 204 is shown as spray nozzles 304a-c. The spray nozzles 204 or 304a-c may be arranged fixed or movably along the boom in regular or irregular distances. Each of the spray nozzles 304a-c may be arranged together with a respective controllable valve 306a-c to regulate dissemination or fluid release of the agricultural substance from the spray nozzles 304a-c to any one or more the geographical locations 108a-d.

One or more tanks 208a-c for containing one or more agricultural substances are shown in fluid communication with the spray nozzles 304a-c through common fluidic line 222, which distributes contents of any of the tanks 208a-c or a mixture of the contents as released from the tanks 208a-c to the spray nozzles 304a-c. Each of the tanks 208a-c holds one or more agricultural substances for the fluid mixture to be released at any one or more of the geographical locations 108a-d. This may include chemically active or inactive ingredients like a herbicide mixture, individual ingredients of a herbicide mixture, a selective herbicide for specific weeds, a fungicide, a fungicide mixture, ingredients of a fungicide mixture, ingredients of a plant growth regulator mixture, a plant growth regulator, water, oil, or any other formulation agent. Each of the tanks 208a-c may further comprise a respective tank valves 306a-c for regulating the dissemination or fluid release from the respective of the tanks 208a-c to the respective fluid lines 308a-c. Such arrangement allows to control the mixture released at any one or more of the geographical locations 108a-d in a targeted manner depending on the conditions sensed at the respective and/or other of the geographical locations 108a-d.

The dissemination is based on one or more signals retrieved from the machine 102 and/or the spray device 202. Some or all of the signals may be retrieved or obtained, for example, by sensing at the spray device 202 via a detection system 220. The detection system 220 may comprise multiple sensors or detection components 218 arranged along the boom. The detection components 218 may be arranged fixed or movable along the boom in regular or irregular intervals. The detection components 218 may be configured to sense one or more conditions at the geographical locations 108a-d, preferably at the geographical location where the farming operation is conducted. The detection components 218 may be, or they may include an optical detection component for providing an image at the geographical location. Certain optical detection components 218 that are suitable for the present teachings include multispectral cameras, stereo cameras, Infrared (“IR”) cameras, Charge-coupled device (“CCD”) cameras, hyperspectral cameras, ultrasonic or light detection and ranging (“LIDAR”) system cameras. Alternatively, or additionally, the detection components 218 may include further sensors to measure humidity, light, temperature, wind or any other suitable condition on the geographical location.

The detection components 218 may, for example, be arranged perpendicular or nearly perpendicular to the movement direction of the spray device 202 and in front of the spray nozzles 304a-c (e.g., seen from drive direction). In the example shown in FIG. 2, the detection components 218 are optical detection components and each of the detection components 218 is associated with a respective of the spray nozzles 204. Now with reference also to FIG. 3, the detection components 218 can be associated such that the respective field-of-view of the respective sensor comprises or at least overlaps with the spray profile 314 of the respective nozzle, e.g., spray nozzle 304c, at that geographical location once the spray nozzle 304c reached the respective position. In other arrangements each of the detection components 218 may be associated with more than one of the spray nozzles 304a-c, or even more than one detection components 218 may be associated with each of the spray nozzles 304a-c.

Now with reference to FIG. 3 along with FIG. 2, as a more detailed example of the spray device 202, it shows the detection components 218, as well as actuators e.g., tank valves 306ac and nozzle valves 310a-c that are communicatively coupled to a control system or control unit 210. In FIG. 2, the control unit 210 is shown located in a main sprayer housing 206, from where it may be operatively coupled via the connectivity interface 104 to the respective components such as sensors and actuators. The connection may be a wired connection to some or all of the components, or it may be a wireless connection. Accordingly, the connectivity interface 104 may allow wired and/or wireless connections. In some cases, it may be more than one control unit 210 or system that may be distributed in the machine 102 and/or the main sprayer housing 206 and communicatively coupled to the detection components 218, the tank valves 306a-c and/or the nozzle valves 310a-c. The control unit 210 may at least partially be the computing unit. Accordingly, the computing unit may either be the control unit 210, or the control unit 210 may be a part of the computing unit. For example, the control unit 210 may communicatively connect with a processing unit of the machine 102 to collectively form and function as the computing unit. The connection may be established via the connectivity interface 104, wired and/or wireless. The processing unit of the machine 102 may be a permanently installed computer or it may be a mobile device that can be detachably connected via the connectivity interface 104. In other cases, the control unit 210 may be a detachable device such as a mobile device that can be connected to the machine 102 or the spray device 202.

The computing unit or the control unit 210 is configured to analyze one or more signals retrieved from the spray device 202 and/or the machine 102. The signals may be retrieved from the detection system 220 that is operatively connected with the machine 102 and/or the spray device 202. For the sake of simplicity, the machine 102 and the spray device 202 will be considered as one apparatus, namely the machine 102, with an assumption that in this example the spray device 202 is attached to the machine 102 for conducting the farming operation. Similarly, control unit 210 and computing unit will be used interchangeably or as simply as control unit 210. Accordingly, the control unit 210 is operatively connected to a memory storage.

The signals are indicative of one or more parameters related to the machine 102 and/or to the farming operation, i.e., the spraying in this example.

In response to the analysis of the one or more signals, the computing unit or control unit 210 is configured to determine whether any one or more of the parameters lie within an acceptable range or value. The range or value is specified using the field specific data that are provided at the memory storage operatively coupled to the control unit 210. The field specific data may be provided from the remote server 106, either directly to the control unit 210, or via a download at the client computer 112 and then a subsequent transfer, wired or wireless via the connectivity interface 104 to the control unit 210.

In response to the determination, the control unit 210 is configured to generate an output signal which is usable for validating and/or specifying the farming operation. The control unit 210 may thus validate if a particular farming operation may be conducted or not, and/or the control unit 210 may specify the farming operation. The farming operation can hence also be controlled via the control unit 210.

The field specific data may be specific to the machine 102, and usable for validating and/or specifying the farming operation. For example, nozzle type or characteristics, and working width. According to an aspect, the field specific data may be weather related, and usable for validating and/or specifying the farming operation. For example, temperature, wind characteristics, precipitation, humidity, solar radiation, bee activity. According to an aspect, the field specific data may be task related, and usable for validating and/or specifying the farming operation. For example, geographical characteristics such as coordinates and/or topographical data of one or more geographical locations or the field, which can provide information related to any one or more of: location, boundary, crop, variety, crop properties, prior crop, tillage system, yield expectation, disease status, and their likes, time window for allowable farming operation, agricultural substance data, dosage, distribution of prior agricultural substances in the field or at one or more geographical locations in the field, recommendation data based on disease status, biomass, weather or legal requirements, execution related data for the farming operation, such as speed, optimal path, overlap, gaps, acceleration, end effector unit selection, for example nozzle selection.

During, or even prior to, the farming operation, the control unit 210 is configured to monitor and/or control the detection components 218 and/or any of the tank valves 306a-c and/or the nozzle valves 310a-c respectively, according to control logic that is provided in the field specific data. The control unit 210 may comprise multiple modules. For example, one module is configured to control the detection components 218 to collect data such as an image or snapshot of measurements at the geographical location. A further module may be configured to analyze the collected data such as the image or measurements for making determination using the field specific data. The further module may even be configured to derive parameters for the tankand/or nozzle valve control. There may even be further modules for controlling the tank valves 306a-c and/or the nozzle valves 310a-c based on the determination or the output signal.

In addition to the control unit 210, the spray device 202 may also comprise a monitoring system 212, which may be any processing device with respective interfaces suitable to receive data measured by the sensor 214 and/or sensor 216 and/or from the control unit 210. In particular, the monitoring system 212 may be configured to receive data from the sensor 214 arranged to measure a fluid property present in the common fluidic line 222. As shown in FIG. 3, the common fluidic line 222 may serve multiple spray nozzles 304a-c with a fluid mixture from the tanks 208a-c. To control the amount of fluid released from the tanks 208a-c, tank valves 306a-c are associated with each of the tanks 208a-c respectively. Depending on the specific conditions sensed on one or more of the geographical locations, the control unit 210 determines characteristics or parameters of the farming operation at the specific geographical location. For example, a specific composition of an agricultural substance or chemical agent to be disseminated or released at the geographical location. Accordingly, the control unit 210, in response to the output signal, provides a respective activation signal to the tank valves 306a-c to provide respective amount of substance to the fluid lines 308a-c respectively. In the example of FIG. 3 one or more of the fluid streams, via respective fluid lines 308a-c, from the tanks 208a-c are mixed in the common fluidic line 222 where the mixture is then fed via distribution lines 302a-c to the individual spray nozzles 304a-c. Each of the spray nozzles 304a-c includes a respective of the nozzle valves 310a-c, which is triggered for spraying depending on the activation signal provided by the control unit 210. Depending on the desired dissemination or application rate provided by the activation signal the application nozzles 312a-c are controlled to spray the respective amount of agricultural substance per activated spray nozzles 304a-c onto the geographical location.

For monitoring the operation of individual spray nozzles 304a-c, sensors monitoring fluid properties can be used. For example, the fluid property sensed in the common fluidic line 222 may be a fluid flow as measured by sensor 214. Further sensors may be used to measure, continuously or intermittently, other fluid properties such as composition and/or temperature and/or pressure of the applied fluid. Such sensors 316a-c may be placed at each of the respective spray nozzles 304a-c as shown in FIG. 3 or even also in the common fluidic line 222 to monitor the composition of the mixture flowing thereto.

The data from the geographical location where the farming operation is conducted may be recorded at the memory storage and/or transmitted directly to the remote server 106. The update data may serve as a basis for providing a new field specific data at the memory storage for validating and/or specifying, or even conducting a future farming operation.

The update data may comprise any one or more of, setpoint for dissemination rate, such as application rate, actual dissemination rate, work state, pressure, work area, working width, tank fill level, composition, pH, status of sections (on/off), geometry, position data, date/time, speed, motor rpm, fuel consumption, environmental sample data, and environment sensor data such as, temperature, wind, precipitation, humidity, solar radiation.

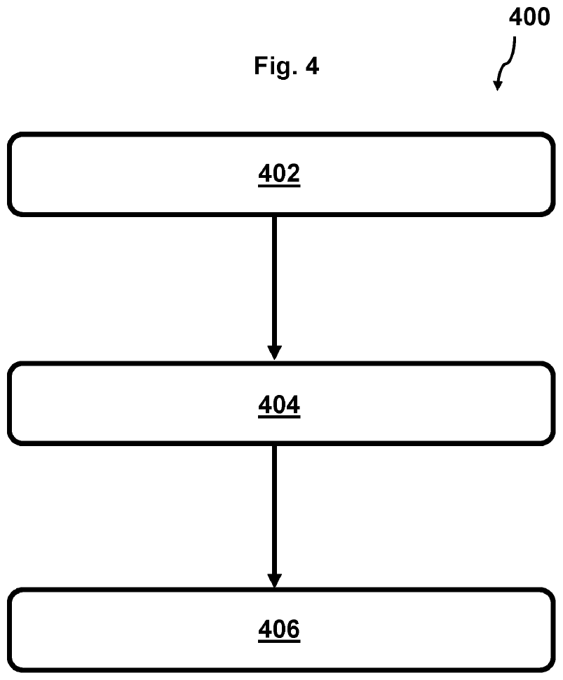

FIG. 4 shows, as a flow-chart 400, the method for performing the agricultural operation at the geographical location using the machine. In block 402, one or more signal retrieved from the machine are analyzed via the computing unit; the one or more signal being indicative of one or more parameter related to the machine and/or to the farming operation. In block 404, it is determined, via the computing unit, whether one or more of the parameters lie within an acceptable range or value. The range or value is specified using the field specific data that are provided at a memory storage operatively coupled to the computing unit. In block 406, it is generated, via the computing unit, an output signal in response to the determination of block 404. The output signal is usable for validating and/or specifying the farming operation.

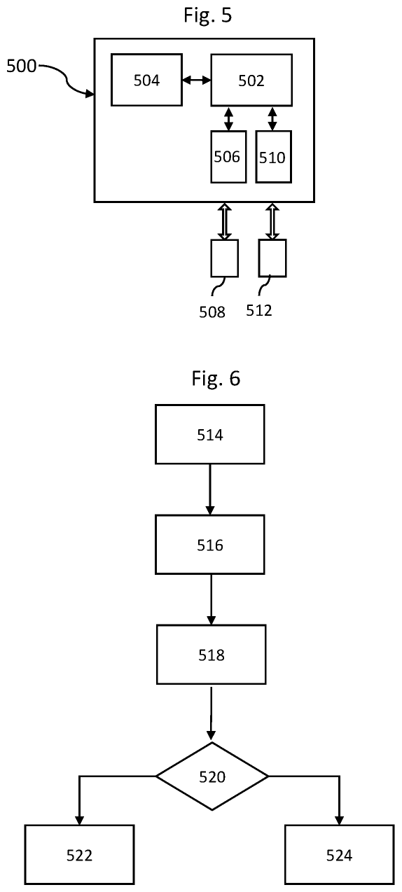

FIG. 5 shows an embodiment of a validation device 500 for validating agricultural farming operations.

The validation device 500 includes a computing unit 502 with one or more processors, a memory storage 504, a network interface and a connectivity interface. The memory storage 504 may include one or more storage units. The storage unit may be persistent or non-persistent storage. The memory storage 504 may include persistent and/or non-persistent storage. The network interface 506 may be configured to provide data related to the process of validating agricultural farming operations, such as field specific data, to or from the remote server 508 such as the cloud server. The connectivity interface 510 may be configured to provide data related to the process of validating agricultural farming operations, such as signals retrieved from the machine 512 being indicative of one or more parameters related to the machine and/or to the farming operation or output signals usable for validating and/or specifying the farming operation, to or from the machine 512. In this context providing data may include to send, to retrieve or to receive data.

FIG. 6 shows an embodiment of the method for validating the agricultural farming operation prior to and/or during execution of the agricultural farming operation.

Via the network interface the field specific data may be provided at the memory storage 504 in step 514, e.g. via the network interface 506 operatively connected to the computing unit 502. The field specific data may be provided from the remote server 508 prior to performing the farming operation on the field. The field specific data may be transferred before the farming operation is conducted. This way the availability of field specific data is ensured such that the machine can operate even when the connection to the server is lost. If connection to the server is available, then also updated field specific data may be transfer during the farming operation. Field specific data may be an immutable set of data defined for a planned operation task and generated on planning of the task. Alternative field specific data may be an immutable set of data defined for a snapshot of the current state of the field specific data. In the latter case field specific data may be updated via the remote server, when field conditions or task planning changes. Hence the field specific data may continuously change on the remote server. In case of a planned task, the field specific data may be synchronized with the machine as soon as a connection to the server is available prior to performing such planned task. If there is no planned task available, the field specific data may be retrieved ad hoc as a snapshot from the current field specific data as stored by the remote server, if the server connection is available. Once a complete set of data is retrieved by the machine, either planned or ad hoc, the operation may start including prior validation. This way it is possible to perform validation without a connection to the server. This is particularly relevant for agricultural fields in rural areas without network.

Field specific data may include data related to the machine and/or to the farming operation. Field specific data may include validation data and/or one or more validation rules for determining whether a certain farming operation may be conducted or not. Said validation data and/or one or more validation rules may for example be provided as a computer logic data or computer instructions for the computing unit 502. Hence, the field specific data may at least partially include computer control logic data for validating one or more farming operations.

Prior to start of the farming operation the computing unit 502 retrieves in step 516 one or more signals indicative of one or more parameters related to the machine and/or to the farming operation e.g. via the connectivity interface 510. Step 516 may be triggered by a farming operation activation signal. Such operation activation signal may be depending on the machine: a spray operation activation signal in case of a sprayer, a tillage operation signal in case of a tiller or a harvest operation signal in case of a harvester.

In step 516, the computing unit 502 retrieves one or more signals being indicative of one or more parameters related to the machine and/or to the farming operation. The operation activation signal may be provided to the computing unit 502 in step 516 and based on the operation activation signal the method for validating farming operation may be initiated. In addition to the operation activation signal further signals may be provided to the computing unit 502. Such signals may include machine related signals such as position of the machine, setpoint, calibration, pre-set calibration intervals, result of previous calibration runs, working parts, setup of working parts, working width, tank fill level, position, date, time or the liken. Such signals may include application related signals such as time stamp of the operation activation signal, measured field conditions such as temperature, wind, humidity, precipitation and/or solar radiation, or the like.

In step 518 the one or more signals retrieved from the machine are provided to the computing unit or analysed by the computing unit. The computing determines based on the field specific data, whether any one or more of the parameters lie within an acceptable range or value. Field-specific data may be provided to the computing unit from the memory storage. The field specific data may include the field location, application data, such as application map, the timing slot of application, (legal) distance requirements, the crop protection product recommendation, driving patterns/instructions, and validation data, validation rules, fall back/correction parameters, information on serverity of consequence in case of violation. Field specific data may also be influenced by or may contain user preferences.

The field specific data may include validation data and/or rules with instructions validating the stored application instructions when the machinery is started for application on the field. Such validation may be based on static or dynamic validation factors. In particular, the validation data and/or one or more validation rules provided via the field specific data may be executed by the computing unit 502. Such validation data and/or validation rules may include:
The field specific data may include an expiration threshold such as an expiration time span or an expiration date. It may be validated that the field specific data based on which the analysis by the computing unit 502 is executed has not been expired.
The field specific data may include operation or task related validation data. Such validation data may include field conditions such as temperature or wind conditions.
The field specific data may include operation or task related rules. For instance the operation or task may be attached to time ranges and/or time slots of the day. Such rules may further be connected to weather conditions present on the specific field such as temperature, precipitation, or wind. Depending on the time and sensor measurements executed in response to the operation activation signal and retrieved as signals from the machine, operation or task related rules may be validated prior to executing farming operation by the machine 512.

In other words, once the machine signals the start of the operation, e.g. via a user interaction, via machine signals or automatically via location coordinates once the machine arrives at the field location, a validation loop may be started. Such validation loop may be based on static validation factors including farming operation specific validation and/or machine specific validation. Farming operation specific validation may include for the application of a crop protection product at least one validation rule based on the application map applicable for the respective field, the time of application, the crop protection products to be applied, the weather conditions on the field expected or measured prior to application of the crop protection product. Machine specific validation may include fill levels of tanks sufficient for the prospective application, valves and nozzles operational and/or check of latest calibration of valves and nozzles still valid.

In step 520 it may be determined, if the one or more parameters lie within an acceptable range.

If the one or more parameters lie within an acceptable range, output signals usable for validating and/or specifying the farming operation are provided in step 522 to the machine 512 via the connectivity interface 510 to start the farming operation.

If the one or more parameters do not lie within an acceptable range, output signals usable for stopping the farming operation are provided in step 524 to the machine 512 via the connectivity interface 510 to stop the farming operation.

Once the validation is completed and successful the machine may receive an output signal. Such output signal may be a validation signal signifying the readiness of the machine 512 for performing the farming operation. In one embodiment such output signal may be displayed on a display. In case of successful validation, a green light may be output via a display of the machine 512 and the operation may start.

If the validation is completed and not successful, e.g. because the timing slot is not valid, output signal may signify that e.g. the operation data does not comply with the situation on the field. Similar signals may be output for the hardware specific validation providing a signal that the hardware is not ready for operation. The machine operation may be stopped automatically.

Output signals may be provided either to a display of the machine 512 or to an intermediary device such as an additional hardware device or a smart phone.

In some instances, the farmer may be allowed to overwrite the unsuccessful validation and continue operation despite the warning. The output signal may include further metadata, such that the operator may be informed via a display about possible ramifications (i.e suboptimal efficacy, loss of yield, loss of warranty). In such case the operator may have to actively confirm such action. Such confirmation may be stored in the memory storage 504, any intermediary device and/or the remote server once the machine 512 connects to the server.

If the validation is completed and not successful, the output signal may include data associated with adjusted operation settings. For instance: application is herbicide, temperature is too high, validation failed, options to increase herbicide dosage, water level or lowered spray nozzles will be provided via output signal. Operation will be started, if a confirmation signal for one of the options is retrieved.

Validation may be clustered into three categories: green for valid operation instructions, yellow for operation instructions that may impact operation success and red for operation instructions that cannot be validated due to the high risk of negative impact. Similar options for adjusting the settings may be flagged. Such validation may be operation measure specific and prepared by the server as part of the field specific data transferred or stored directly by the validation device 500. If no field specific validation data or validation rule may be available (because no connection to the server) and the operator wants to perform an operation, default operation values may be used and the operator may be notified about such non-validated default mode.

In addition or alternatively to the above embodiment, the computing unit 502 may retrieve one or more signals indicative of one or more parameters related to the machine and/or to the farming operation, analyzes the one or more signals retrieved from the machine 512 and determines based on the field data, in particular the validation data and/or one or more validation rules, whether any one or more of the parameters lie within an acceptable range or value and if the one or more parameters lie within an acceptable range, provides output signals usable for validating and/or specifying the farming operation to the machine via the connectivity interface. This way it is enabled to control and/or monitor the farming operation not only prior to starting the farming operation, but also during performance of the farming operation.

For instance during the performance of the farming operation, data from the machine may be continuously retrieved. Such data may be retrieved from machine sensors, field sensors, machine implements sensors or other machine sensors. The data may be analyzed and checked based on the field specific data, in particular the validation data and/or one or more validation rules, during the farming operation. For example:
Check if application rate is correct for current part of the field (setpoint and actual application rate are considered)
Check if sections are correctly set (for overlapping, distance requirements and on/off applications)
Check if temperature is within defined ranges
Check if wind is within defined ranges (also dependent on product, nozzles, driving speed)
Check if driving speed is within defined ranges (also dependent on nozzles and pressure and application rate->all parameters need to be aligned to have good droplet size)
Check if date and time for performing the farming operation is within defined ranges for the current field

The validation loop may include dynamic factors that can be validated during application operation on the field. In that case sensors of the machinery deliver data such as weather data, machinery data (e.g. speed, pressure in the nozzle system, . . . ) or other data available on-board of the machine during operation in the field from in-field sensors or in case of server connectivity being present from the server may be provided. The validation instructions may in such case include a tailored set of validation parameters relevant for the specific operation and respective operation ranges. E.g. if the temperature on the field rises to a value higher than allowed for a certain period of time the validation instructions may lead to a respective warning triggered by the system. Similarly, if wind speed increases over certain period of time the validation instructions may lead to a respective warning triggered by the system. Such dynamic warning may be clustered in line with static warnings and may trigger active confirmation screens for the user.

In any case the on-field operation data such as as-applied-maps, overwritten warnings, user interaction, validation results, sensor readings . . . will be stored on memory sorage 504 and transferred to the server. Once the server receives information relating to overwritten warnings, a further process may be triggered that assesses the impact of such overwrite. For instance if the farmer has overwritten red warnings, the server system may trigger a notification to the farmer signifying the cause and optionally the loss of warranty. Further for instance if the farmer has overwritten yellow warnings, the server system may trigger a notification to the farmer signifying the cause for the yellow warning and an estimation of a worst-case impact on application success. The field may be monitored regarding such specific impact and should it materialize no warranty incident may be triggered. In any other case warranty incident may be triggered. The additional insights gathered from this process may also influence or be contained in future field specific data transferred to the machinery. E.g if in a previous application a warning was overwritten this may impact the field specific data for a future application.

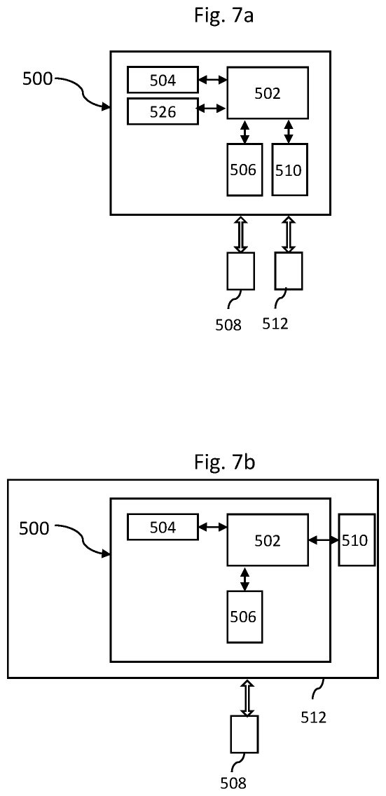

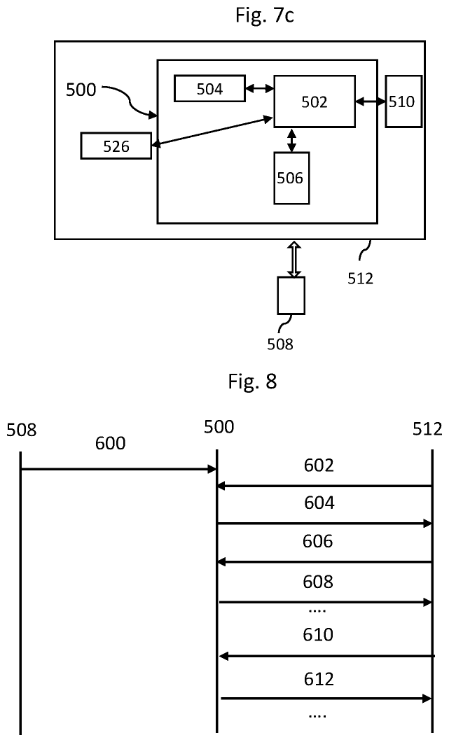

FIGS. 7a to c show different configurations of the validation device for validating agricultural farming operations.

The validation device 500 of FIG. 7a is a mobile device configured to retrieve field specific data from the remote server, to run the method for validating agricultural farming operations and to provide output signals usable for validating and/or specifying the farming operation. In such an embodiment a mobile connection interface of the machine 512 may be configured to send or obtain data from the mobile device 500 or to retrieve or receive data from the mobile device 500. The interface 510 enabling connection of the mobile device 500 with the machine 512 may be based on a wireless connectivity interfaces such as Wifi or Bluetooth. The mobile device 500 may be communicatively connected to the machine 512 via wireless local connection (Bluetooth, wifi, . . . ). The mobile connection interface of the machine 512 may be connected to the machine hardware via a wired connection such as a CAN BUS using protocols such as ISOBUS and J1939. Serial or other connections and other protocols can also be use for a connection of the mobile device 500 to the machine 512. The mobile device 500 can further provide extended functionality to the machine 512. Such functionalities include the method for validating farming operations as well as additional functionalities such as displaying data and allowing for user interaction via a HMI such as a touch screen. For that the mobile device 500 may include memory storage 504 configured to provide the field specific data to the computing unit 502, computing unit 502 configured to execute the method for validating farming operations and to provide output signals usable for validating and/or specifying the farming operation, a display 526 configured to display output signals usable for validating and/or specifying the farming operation and the interfaces 506, 510 to the remote server 508 or the machine 512 respectively.

The validation device 500 of FIG. 7b is an embedded device configured to retrieve field specific data from the remote server, to run the method for validating agricultural farming operations and to provide output signals usable for validating and/or specifying the farming operation. Such embedded device may be connected to the machine via connectivity interfaces and to the remote server via a network interface. The connectivity interface to the machine may be based on a CAN BUS and the network interface may be based on Bluetooth, Wifi or a cellular network.

The embedded device of FIG. 7b is a dedicated device configured to retrieve field specific data from the remote server, to run the method for validating agricultural farming operations and to provide output signals usable for validating and/or specifying the farming operation. Additional functionalities such as displaying data and allowing for user interaction via a HMI may be provided by additional hardware components. For instance, a HMI including a display may be provided by a separate mobile device.

The embedded device of FIG. 7c is a fully integrated device configured to perform the method for validating farming operations. In this embodiment existing hardware on the machine may be updated with software instructions to perform the method for validating farming operations. The fully integrated device may already provide for the required interfaces to perform the method. The fully integrated device may include the connectivity interface to control unit(s) of the machine, the HMI of the machine and the network interface. This way existing hardware may be used and extended with software that retrieves data from the server, runs the validation logic and displays on the user interface.

The validation device of FIG. 7c is a partially embedded device configured to run the method for validating agricultural farming operations and to provide output signals usable for validating and/or specifying the farming operation. The mobile device is configured to retrieve field specific data from the remote server and provide it to the partially embedded device. A mobile connection interface of the machine or the validation device may be configured to send or obtain data from the mobile device or to retrieve or receive field specific data from the mobile device.

As lined out above different hardware configurations may be used to implement the validation device. For instance hardware already available on the machine may be used or an additional validation device that can be connected to the machine, like a sprayer or a seeder or any other agricultural machine used for farming operations may be used. The validation device may include a memory storage, a connectivity interface to the machinery such as the implement, the tractor or sensors, a network interface to the remote server and the computing unit. The validation device may be fitted to the machine as an additional hardware device, built in as stationery part or implemented in a separate mobile device. The communications to the machine may be be based on publicly available protocols, such as ISOBUS and J1939, or any other suitable protocols. In the case, where connectivity interfaces for the validation device are needed, near field communication such as Bluetooth or far field communication protocols may be used. To enable farming operation for a specific field, field-specific data including field specific operation instructions may be transferred from the server to the memory storage of the validation device. Such transfer may be conducted directly or via an intermediate device such as an additional dongle or a smart phone.

FIG. 8 shows an example of a data flow between different components of the distributed computing system of FIG. 1.

Before the farmer intends to execute the farming operation, field specific data may be transferred from the remote server 508 to validation device 500, in particular the memory storage 504 of the validation device 500. As shown in FIGS. 7a to 7c the validation device may be configured in different hardware set-ups. Such data transfer is signified by reference numeral 600.

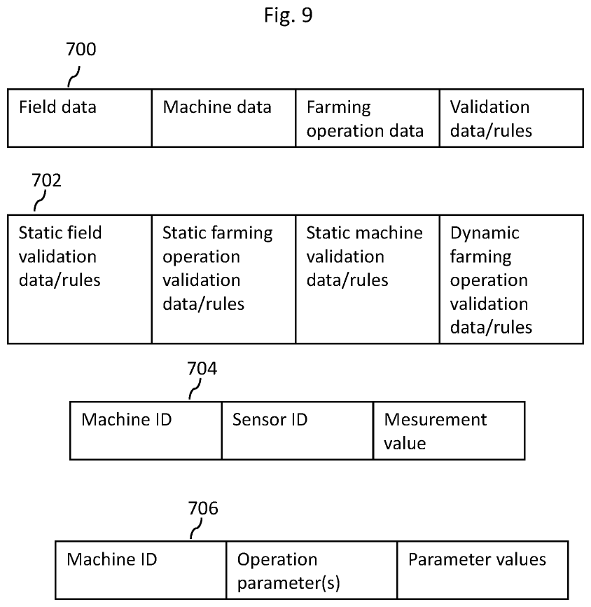

FIG. 9 illustrates the header of an example data package 700 that may be exchanged in step 600. Field-specific data may include a field data related to the field location the farming operation is to be performed. This may include data related to the position of the field such as longitude and latitude values e.g. in WGS84 combined with a field boundary and buffer zones applicable to the field. Field-specific data may include a machine data associated with the machine and specifying e.g. a machine type, a machine setup such as in case of a sprayer number of tanks, valves or nozzles, or calibration data related to e.g. calibration intervals or results of previous calibrations. Field-specific data may include a farming operation data related to the operation to be performed on the field. Such operation data may include for instance for the application of a crop protection product an identifier for the cop protection product to be applied, a time range for performing the application, field condition ranges for performing the application, a spatially resolved application map and/or driving instructions.

Field specific data may include validation data and/or validation rules 702. The validation data and/or validation rules may relate to parameters related to the machine and/or to the farming operation. The validation data and/or validation rules may be based on parameters related to the machine and/or to the farming operation. The validation data and/or validation rules may indicate an acceptable range or value for the parameters related to the machine and/or to the farming operation. The validation data and/or validation rule may include instructions for validating the stored field data as soon as the machinery is started for performing the agricultural operation. Such validation may be based on static or dynamic validation factors.

On activation of the machine 512 to perform the farming operation, the operation activation signal may be provided from the machine 512 to the validation device 500. Such data transfer is signified by reference numeral 602.

On retrieval of the operation activation signal, the validation device 500 may initiate the method for validating farming operations. On initiation the field specific data, in particular the validation data and/or validation ruled stored in the memory storage 504 may be loaded to the computing device. The validation device may request from the machine 512 one or more signals indicative of one or more parameters related to the machine and/or to the farming operation. Such data transfer is signified by reference numeral 604.

On retrieval of the request, the machine 512 may provide one or more signals indicative of one or more parameters related to the machine and/or to the farming operation to the validation device 500. Such data transfer is signified by reference numeral 606. FIG. 9 illustrates the header of an example data package 704 that may be exchanged in step 606.

On retrieval of one or more signals indicative of one or more parameters related to the machine and/or to the farming operation, the validation device 500 determines, via the computing unit 502, whether any one or more of the parameters lie within an acceptable range or value, which range or value is specified using field specific data. Based on such determination the output signal usable for validating and/or specifying the farming operation is generated. The output signal may be provided to the machine 512. Such data transfer is signified by reference numeral 608. FIG. 9 illustrates the header of an example data package 706 that may be exchanged in step 608.

The output signal may be associated with a validation signal signifying the start of the farming operation. The output signal may be associated with operating parameters to control operation of the machine. The output signal may be associated with operating parameters to control operation of the machine associated with a confirmation request to be confirmed by an operator of the machine. The output signal may be associated with a denial signal signifying to stop or not start farming operation with the machine.

On retrieval of the output signal by the machine for performing the farming operation, the machine may control farming operation based on the retrieved output signal. If the output signal provides the machine with a validation or conditional validation, the control system of the machine 512 may operate according to the provided operation parameters. If the output signal provides the machine with no validation or conditional validation, the control system of the machine 512 may block performance of the farming operation.

During performance of the farming operation, the machine 512 may provide one or more signals indicative of one or more parameters related to the machine and/or to the farming operation to the validation device 500. Such data transfer is signified by reference numeral 610. On retrieval of such signals, the validation device may generate respective output signals and provide such output signals to control operation of the machine 500 during performance of the farming operation. Such data transfer is signified by reference numeral 612. This way it can be ensured that the farming operation by way of control of machine 500 performing the farming operation is performed in a robust and reliable manner.

The word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

Various examples have been disclosed above for a method for performing an agricultural farming operation at a geographical location using a machine operatively coupled to a computing unit; a machine for performing the agricultural farming operation; a computer software product implementing any of the relevant method steps herein disclosed; a computing unit comprising the computer program code for carrying out the method herein disclosed; and a computing unit operatively coupled to a memory storage comprising the computer program code for carrying out the method herein disclosed. Those skilled in the art will understand however that changes and modifications may be made to those examples without departing from the spirit and scope of the accompanying claims and their equivalents. It will further be appreciated that aspects from the method and product embodiments discussed herein may be freely combined.

Summarizing and without excluding further possible embodiments, at least the following embodiments listed as clauses may be envisaged:

Clause 1. A method for performing an agricultural farming operation at a geographical location using a machine, preferably a method for validating an agricultural farming operation prior to and/or during executing an agricultural farming operation at a geographical location using a machine, the machine being operatively coupled to a computing unit, which method comprises:
analyzing, via the computing unit, or providing to one or more signals retrieved from the machine; the one or more signals being indicative of one or more parameters related to the machine and/or to the farming operation;
determining, via the computing unit, whether any one or more of the parameters related to the machine and/or to the farming operation lie within an acceptable range or value, which acceptable range or value is specified using field specific data that are provided at a memory storage operatively coupled to the computing unit; and
generating, via the computing unit, an output signal in response to the determination; wherein the output signal is usable for validating and/or specifying the farming operation preferably to monitor and/or control the machine.
   Clause 2. The method of clause 1, wherein the field specific data have an expiry date beyond which date the computing unit is prevented from using said field specific data.
   Clause 3. The method of clause 1, wherein the field specific data are provided via a data transfer from a remote server.
   Clause 4. The method of clause 3, wherein the computing unit is operatively coupled to a network interface, and wherein data transfer is performed via the network interface.
   Clause 5. The method of any of the above clauses, wherein the computing unit is operatively coupled to a connectivity interface.
   Clause 6. The method of clause 5, wherein the network interface and the connectivity interface are the same device.
   Clause 7. The method of any of the above clauses, wherein the farming operation involves dissemination of at least one agricultural substance.
   Clause 8. The method of clause 7, wherein specifying of the farming operation comprises selection of any one or more of the at least one agricultural substance for dissemination at the geographical location, preferably the selection at least partly being performed dependent upon any one or more of the parameters, or in response to the output signal.
   Clause 9. The method of clause 7 or clause 8, wherein specifying of the farming operation comprises determining the quantity and/or concentration of any one or more of the at least one agricultural substance for dissemination at the geographical location, preferably the quantity and/or concentration at least partly being determined dependent upon any one or more of the parameters, or in response to the output signal.
   Clause 10. The method of any of the above clauses, wherein specifying of the farming operation comprises determining at least one distance value for conducting the farming operation.
   Clause 11. The method of any of the above clauses, wherein validating of the farming operation comprises determining whether the farming operation can be safely and/or efficiently conducted.
   Clause 12. The method of any of the above clauses, wherein validating of the farming operation comprises determining whether the machine is adequately equipped for conducting the farming operation.
   Clause 13. The method of any of the above clauses, wherein validating the farming operation involves performing a static validation which is performed by the computing unit under static or near static conditions of the machine, such as, prior to conducting the farming operation.
   Clause 14. The method of any of the above clauses, wherein validating the farming operation involves performing a dynamic validation that involves one or more checks or determinations that are performed by the computing unit while the machine is being used during conducting the farming operation.
   Clause 15. The method of any of the above clauses, wherein a location of the geographical location is determined via a geolocation module operatively coupled to the computing unit.
   Clause 16. The method of any of the above clauses, wherein the output signal is provided to a Human Machine Interface (“HMI”), operatively coupled to the computing unit, for communicating the validated and/or specified farming operation.
   Clause 17. The method of any of the above clauses, wherein the farming operation is prevented from being conducted in response to the output signal.
   Clause 18. The method of clause 17, wherein the prevented farming operation is user overridable.
   Clause 19. The method of clause 18, wherein an exception signal is generated via the computing unit when the prevented farming operation is overridden.
   Clause 20. The method of clause 19, wherein the exception signal is provided at the memory storage and/or at the remote server.
   Clause 21. The method of any of the above clause 1 to clause 16, wherein the farming operation is conducted and/or controlled in response to the output signal.
   Clause 22. The method of clause 21, wherein the farming operation is conducted and/or controlled via the computing unit, preferably by the computing unit controlling at least one actuator and/or at least one end effector unit related to the machine.
   Clause 23. The method of clause 21 or clause 22, wherein the computing unit provide update data at the memory storage and/or to the remote server, the update data comprising any of the one or more signals and/or any of the one or more parameters related to the geographical location, and/or the validation and/or specification of the farming operation at the geographical location.
   Clause 24. The method of clause 20 and clause 23, wherein the exception signal is provided as a part of the update data.
   Clause 25. The method of clause 23 or clause 24, wherein the update data is used for generating updated field specific data usable by the computing unit for a future farming operation at or around the geographical location.
   Clause 26. A machine for performing an agricultural farming operation, the machine being configured according to any of the above method clauses, and the machine being configured such to perform the method steps according to any of the above clauses.
   Clause 27. A computer program, or a non-transitory computer readable medium storing the program, comprising instructions which, when the program is executed by a suitable computing unit, cause the computing unit to carry out the method steps of any of the above method clauses.
   Clause 28. A machine for performing an agricultural farming operation at a geographical location, the machine being operatively coupled to a computing unit, and the computing unit being operatively a memory storage, the machine being adapted such that the computing unit is configured to:
analyze one or more signals retrieved from the machine; the one or more signals being indicative of one or more parameters related to the machine and/or to the farming operation;
determine whether any one or more of the parameters lie within an acceptable range or value, which range or value is specified using field specific data that are provided at the memory storage; and
generate an output signal in response to the determination; wherein the output signal is usable for validating and/or specifying the farming operation.
   Clause 29. A computer program, or a non-transitory computer readable medium storing the program, comprising instructions which, when the program is executed by a suitable computing unit operatively coupled to: a memory storage, and a machine for performing an agricultural farming operation at a geographical location, causes the computing unit to:
analyze one or more signals retrieved from the machine; the one or more signals being indicative of one or more parameters related to the machine and/or to the farming operation;
determine whether any one or more of the parameters lie within an acceptable range or value, which range or value is specified using field specific data that are provided at the memory storage; and
generate an output signal in response to the determination;
wherein the output signal is usable for validating and/or specifying the farming operation.
   Clause 30. A computing unit comprising the computer program code for carrying out the method steps of any of the above method clauses.
   Clause 31. A computing unit operatively coupled to a memory storage comprising the computer program code for carrying out the method steps of any of the above method clauses.

1. A method for validating an agricultural farming operation prior to and/or during executing an agricultural farming operation at a geographical location using a machine, the machine being operatively coupled to a computing unit, which method comprises:
providing to the computing unit one or more signals retrieved from the machine, the one or more signals being indicative of one or more parameters related to the machine and/or to the farming operation;
determining, via the computing unit, whether any one or more of the parameters related to the machine and/or to the farming operation lie within an acceptable range or value, which acceptable range or value is specified using field specific data that are provided at a memory storage operatively coupled to the computing unit; and
generating, via the computing unit, an output signal in response to the determination; wherein the output signal is usable for validating and/or specifying the farming operation to monitor and/or control the machine.

2. The method of claim 1, wherein the field specific data have an expiry date beyond which date the computing unit is prevented from using said field specific data.

3. The method of claim 1, wherein the farming operation involves dissemination of at least one agricultural substance.

4. The method of claim 3, wherein specifying of the farming operation comprises selection of any one or more of the at least one agricultural substance for dissemination at the geographical location, preferably the selection at least partly being performed dependent upon any one or more of the parameters, or in response to the output signal.

5. The method of claim 3, wherein specifying of the farming operation comprises determining the quantity and/or concentration of any one or more of the at least one agricultural substance for dissemination at the geographical location, preferably the quantity and/or concentration at least partly being determined dependent upon any one or more of the parameters, or in response to the output signal.

6. The method of claim 1, wherein validating the farming operation involves performing a static validation which is performed by the computing unit under static or near static conditions of the machine, such as, prior to conducting the farming operation and/or validating the farming operation involves performing a dynamic validation that involves one or more determinations that are performed by the computing unit while the machine is being used during conducting the farming operation.

7. The method of claim 1, wherein the output signal includes data specifying the farming operation, a user confirmation for executing the farming operation, a warning and/or an user overridable signal to prevent farming operation.

8. The method of claim 1, wherein the determination whether any one or more of the parameters related to the machine and/or to the farming operation lie within an acceptable range or value is triggered based on an operation activation signal from the machine.

9. The method of claim 1, wherein an output signal is generated to prevent farming operation from being conducted in response to on one or more of the parameters related to the machine and/or to the farming operation not lying within an acceptable range or value.

10. The method of claim 9, wherein the output signal to prevent farming operation is user overridable, wherein an exception signal is generated when the prevented farming operation is overridden, wherein the exception signal is provided at the memory storage and/or at a remote server.

11. The method of claim 1, wherein field specific data relates to the machine and/or to the farming operation and/or validation data and/or one or more validation rule(s).

12. The method of claim 1, wherein the farming operation is conducted, monitored and/or controlled in response to the output signal.

13. A validation device including a computing unit operatively coupled to a memory storage comprising the computer program code for carrying out the method steps of claim 1.

14. A machine for performing an agricultural farming operation at a geographical location, the machine being operatively coupled to a computing unit, and the computing unit being operatively a memory storage, the machine being adapted such that the computing unit is configured to:
provide one or more signals retrieved from the machine, the one or more signals being indicative of one or more parameters related to the machine and/or to the farming operation;
determine whether any one or more of the parameters related to the machine and/or to the farming operation lie within an acceptable range or value, which acceptable range or value is specified using field specific data that are provided at the memory storage; and
generate an output signal in response to the determination; wherein the output signal is usable for validating and/or specifying the farming operation to monitor and/or control the machine.

15. A computer program, or a non-transitory computer readable medium storing the program, comprising instructions which, when the program is executed by a suitable computing unit operatively coupled to a memory storage, causes the computing unit to:
provide one or more signals retrieved from the machine, the one or more signals being indicative of one or more parameters related to the machine and/or to the farming operation;
determine whether any one or more of the parameters related to the machine and/or to the farming operation lie within an acceptable range or value, which acceptable range or value is specified using field specific data that are provided at the memory storage; and
generate an output signal in response to the determination;
wherein the output signal is usable for validating and/or specifying the farming operation to monitor and/or control the machine.
